(19) United States
(12) Patent Application Publication
(10) Pub. No.: US 2023/0208966 A1
(43) Pub. Date: Jun. 29, 2023

(54) DETERMINATION METHOD, INFORMATION PROCESSING APPARATUS, AND COMPUTER-READABLE RECORDING MEDIUM STORING DETERMINATION PROGRAM

(71) Applicant: Fujitsu Limited, Kawasaki-shi (JP)

(72) Inventors: Mingxie Zheng, Kawasaki (JP); JUN TAKAHASHI, Kawasaki (JP); Toshiyuki Yoshitake, Kawasaki (JP); Kentaro TSUJI, Kawasaki (JP); Masayoshi SHIMIZU, Hadano (JP)

(73) Assignee: Fujitsu Limited, Kawasaki-shi (JP)

(21) Appl. No.: 17/960,200

(22) Filed: Oct. 5, 2022

(30) Foreign Application Priority Data
Dec. 23, 2021 (JP) 2021-209901

(51) Int. Cl. H04M 3/22; G06F 16/71; G06V 20/40

(52) U.S. Cl. CPC H04M 3/2281; G06F 16/71; G06V 20/44; G06V 20/46

(57) ABSTRACT

A determination method includes: receiving first sensing data that includes either video or voice generated in a first remote call made between a first account and a second account and second sensing data that includes either video or voice generated in a second remote call made between the first account and the second account; referring to a storage unit that stores feature information extracted when a specific situation for a person who corresponds to the first account occurs in the first sensing data in association with the specific situation when occurrence of the specific situation for the person who corresponds to the first account is detected in the second sensing data; and making determination related to spoofing on a basis of a matching state between the feature information for the specific situation in the storage unit and the feature information for the specific situation detected from the second sensing data.

### CROSS-REFERENCE TO RELATED APPLICATION

This application is based upon and claims the benefit of priority of the prior Japanese Patent Application No. 2021-209901, filed on Dec. 23, 2021, the entire contents of which are incorporated herein by reference.

### FIELD

The embodiments discussed herein are related to a determination method, an information processing apparatus, and a determination program.

### BACKGROUND

In recent years, synthetic media using images and sounds generated and edited using artificial intelligence (AI) have been developed, and are expected to be used in various fields. On the other hand, synthetic media manipulated for improper purposes has become a social problem.

Japanese Patent No. 6901190 and Japanese Laid-open Patent Publication No. 2008-15800 are disclosed as related art.

### SUMMARY

According to an aspect of the embodiments, a determination method includes: receiving first sensing data that includes either video or voice generated in a first remote call made between a first account and a second account and second sensing data that includes either video or voice generated in a second remote call made between the first account and the second account; referring to a storage unit that stores feature information extracted when a specific situation for a person who corresponds to the first account occurs in the first sensing data in association with the specific situation when occurrence of the specific situation for the person who corresponds to the first account is detected in the second sensing data; and making determination related to spoofing on a basis of a matching state between the feature information for the specific situation in the storage unit and the feature information for the specific situation detected from the second sensing data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a hardware configuration of a computer system as an example of a first embodiment;

FIG. 2 is a diagram exemplifying a functional configuration of the computer system as an example of the first embodiment;

FIG. 3 is a diagram exemplifying a plurality of databases included in a database group in the computer system as an example of the first embodiment;

FIG. 4 is a diagram exemplifying a specific situation database 1051 in the computer system as an example of the first embodiment;

FIG. 5 is a diagram exemplifying a feature amount extraction database in the computer system as an example of the first embodiment;

FIG. 6 is a diagram exemplifying specific situation behavior in the computer system as an example of the first embodiment;

FIG. 7 is a diagram exemplifying a specific situation number database in the computer system as an example of the first embodiment;

FIG. 8 is a diagram exemplifying a specific situation behavior database in the computer system as an example of the first embodiment;

FIG. 9 is a diagram exemplifying a presentation sentence database in the computer system as an example of the first embodiment;

FIG. 10 is a diagram for explaining processing by a behavior comparison unit in the computer system as an example of the first embodiment;

FIG. 11 is a diagram exemplifying an output image of a spoofing detection result in the computer system as an example of the first embodiment;

FIG. 12 is a flowchart for explaining a process of a first specific situation determination unit in the computer system as an example of the first embodiment;

FIG. 13 is a flowchart for explaining a process of a first behavior extraction unit in the computer system as an example of the first embodiment;

FIG. 14 is a flowchart for explaining a process of a specific situation behavior storage processing unit in the computer system as an example of the first embodiment;

FIGS. 15A and 15B are a flowchart for explaining a process of a second specific situation determination unit in the computer system as an example of the first embodiment;

FIG. 16 is a flowchart for explaining a process of a second behavior extraction unit in the computer system as an example of the first embodiment;

FIG. 17 is a flowchart for explaining a process of the behavior comparison unit in the computer system as an example of the first embodiment;

FIG. 18 is a flowchart for explaining a process of an evaluation unit in the computer system as an example of the first embodiment;

FIG. 19 is a diagram exemplifying simulation using spoofing detection processing in the computer system as an example of the first embodiment;

FIG. 20 is a diagram exemplifying a functional configuration of a computer system as an example of a second embodiment;

FIG. 21 is a diagram exemplifying a specific situation frequency database in the computer system as an example of the second embodiment;

FIG. 22 is a flowchart for explaining a process of a specific situation selection unit in the computer system as an example of the second embodiment;

FIGS. 23A and 23B are a flowchart for explaining a process of a second specific situation determination unit in the computer system as an example of the second embodiment;

FIG. 24 is a diagram exemplifying simulation using spoofing detection processing in the computer system as an example of the second embodiment;

FIG. 25 is a diagram exemplifying a functional configuration of a computer system as an example of a third embodiment;

FIG. 26 is a diagram exemplifying specific situation creation question information in the computer system as an example of the third embodiment;

FIGS. 27A and 27B are a flowchart for explaining a process of a second specific situation determination unit in the computer system as an example of the third embodiment;

FIG. 28 is a diagram exemplifying a functional configuration of a computer system as an example of a fourth embodiment;

FIG. 29 is a diagram exemplifying specific situation guidance information in the computer system as an example of the fourth embodiment; and

FIGS. 30A and 30B are a flowchart for explaining a process of a second specific situation determination unit in the computer system as an example of the fourth embodiment.

### DESCRIPTION OF EMBODIMENTS

The synthetic media manipulated for improper purposes may be referred to as deepfake. Furthermore, a fake image generated by deepfake may be referred to as a deepfake image, and fake video generated by deepfake may be referred to as deepfake video.

Due to technological evolution of AI and enhancement of computer resources, it has become technically possible to generate deepfake images and deepfake video that do not exist in reality, and fraudulent damage or the like caused by the deepfake images and deepfake video has become a social problem.

Additionally, the damage may further increase if the deepfake images and the deepfake video are fraudulently used for spoofing.

For example, in order to detect the deepfake video based on the synthetic media, there has been known a technique of comparing, during a remote conversation via the Internet, past and current behavior from the remote conversation to issue a warning indicating that the participant is not the identical person if the behavior does not match.

However, according to such an existing deepfake determination method, it is not possible to compare the behavior if past behavior expected to appear at the present time does not appear, and the determination may not be made.

For example, in a case where, while there has been behavior of covering a mouth with a hand in a fun conversation in the past, a current conversation topic is a sad thing so that the behavior detected in the past does not appear, the determination may not be made.

Furthermore, in a case where behavior is imitated from past data to be similar to the current behavior, it is difficult to determine the deepfake.

In one aspect, the embodiments aim to improve accuracy in detecting spoofing in remote calls.

Hereinafter, embodiments of the present determination method, information processing apparatus, and determination program will be described with reference to the drawings. Note that the embodiments to be described below are merely examples, and there is no intention to exclude application of various modifications and techniques not explicitly described in the embodiments. For example, the present embodiments may be implemented by making various modifications (e.g., by combining the individual embodiments) without departing from the spirit of the present embodiments. Furthermore, each drawing is not intended to include only components illustrated in the drawing, and may include another function and the like.

(I) Description of First Embodiment

(A) Configuration

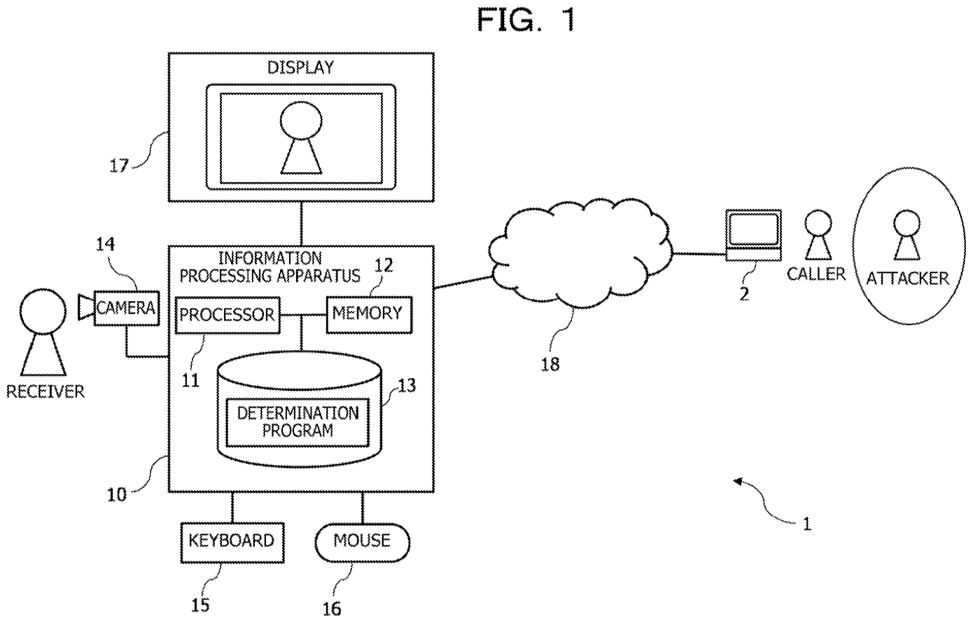

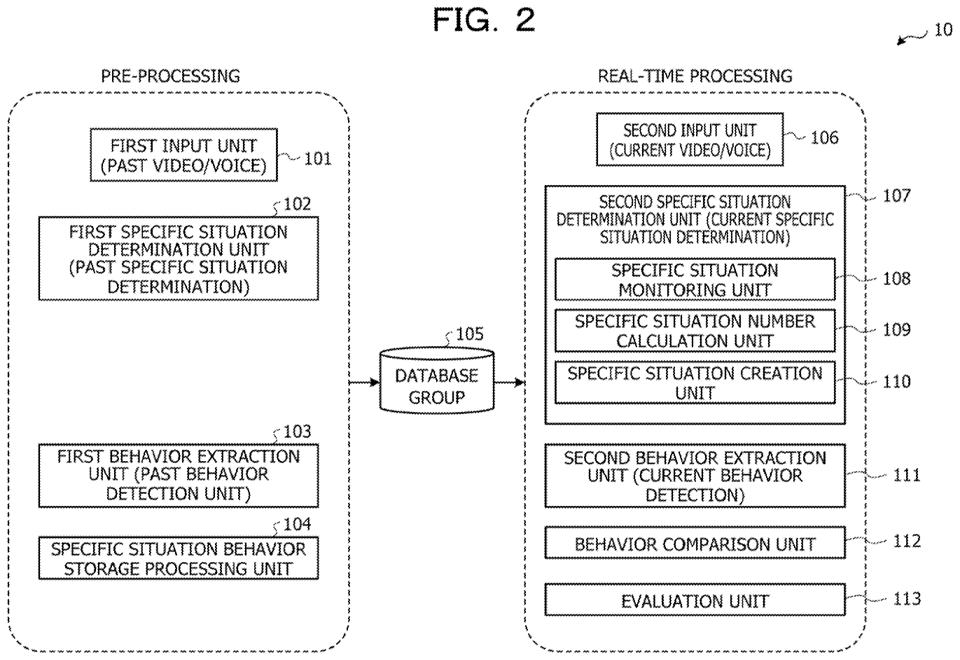

FIG. 1 is a diagram schematically illustrating a hardware configuration of a computer system 1 as an example of a first embodiment, and FIG. 2 is a diagram exemplifying a functional configuration thereof.

The computer system 1 exemplified in FIG. 1 includes an information processing apparatus 10 and an interlocutor terminal 2. Those information processing apparatus 10 and the interlocutor terminal 2 are connected in a mutually communicable manner via a network 18.

The computer system 1 achieves a remote conversation between a user of the information processing apparatus 10 and a user of the interlocutor terminal 2 via the network 18.

A remote call is made between two or more accounts out of a plurality of accounts set to be enabled to participate in the remote call.

In the present computer system 1, the information processing apparatus 10 carries out spoofing detection processing for detecting whether video transmitted from the interlocutor terminal 2 is of the user of the interlocutor terminal 2 or fake video (deepfake video) generated by an attacker using synthetic media.

Hereinafter, the user of the interlocutor terminal 2 may be referred to as a caller, and the user of the information processing apparatus 10 may be referred to as a receiver. The attacker impersonates this caller, and uses an account (first account) of the caller to have a remote conversation with the receiver. When the attacker carries out spoofing using deepfake video, the caller is actually the attacker. The caller or the attacker impersonating the caller joins the remote call using the first account. Furthermore, the receiver joins the remote call using a second account.

In the present computer system 1, behavior taken in a situation where in what situation the behavior has been taken is known (hereinafter referred to as a specific situation) is likely to be commonly taken in a similar situation as compared with a case with no restriction. Then, spoofing detection is implemented on the premise that the behavior taken in the past may be taken by reproducing the specific situation of the behavior taken in the past.

Furthermore, it is assumed that the attacker imitates the behavior of the caller from past remote conversation data (video data) of only the caller. Therefore, the attacker does not know the specific situation where the caller has taken the specific behavior.

It is assumed that a behavior pattern received by the receiver in the specific situation is commonly different between the case with no spoofing (i.e., behavior of the caller) and the case with spoofing (i.e., behavior of the attacker).

It is assumed that the receiver may recognize the behavior taken by the caller in the past specific situation from history data (past video) of the remote conversation with the caller.

It is assumed that the past video that may be referred to by the attacker is only video in which the caller appears, and that the past video that may be referred to by the receiver is both of video in which the caller appears and video in which the receiver appears.

As illustrated in FIG. 1, the information processing apparatus 10 includes a processor 11, a memory 12, a storage device 13, a camera 14, a keyboard 15, a mouse 16, a display 17, and a database group 105.

The processor (control unit) 11 is a processor that takes overall control of the information processing apparatus 10. The processor 11 may be a multiprocessor. The processor 11 may be, for example, any one of a central processing unit (CPU), a micro processing unit (MPU), a digital signal processor (DSP), an application specific integrated circuit (ASIC), a programmable logic device (PLD), and a field programmable gate array (FPGA). Furthermore, instead of the CPU, a combination of two or more types of elements of the CPU, MPU, DSP, ASIC, PLD, and FPGA may be used. The processor 11 may be a graphics processing unit (GPU).

Additionally, in the present computer system 1, the processor 11 executes a determination program, thereby implementing functions as a first input unit 101, a first specific situation determination unit 102, a first behavior extraction unit 103, a specific situation behavior storage processing unit 104, a second input unit 106, a second specific situation determination unit 107, a second behavior extraction unit 111, a behavior comparison unit 112, and an evaluation unit 113 to be described later with reference to FIG. 2.

Note that the program (determination program) for implementing the functions as those first input unit 101, the first specific situation determination unit 102, the first behavior extraction unit 103, the specific situation behavior storage processing unit 104, the second input unit 106, the second specific situation determination unit 107, the second behavior extraction unit 111, the behavior comparison unit 112, and the evaluation unit 113 is provided in a form recorded in a computer-readable recording medium such as a flexible disk, a compact disc (CD) (CD-read only memory (ROM), CD-recordable (R), CD-rewritable (RW), etc.), a digital versatile disc (DVD) (DVD-ROM, DVD-random access memory (RAM), DVD-R, DVD+R, DVD-RW, DVD+RW, high-definition (HD) DVD, etc.), a Blu-ray disc, a magnetic disc, an optical disc, a magneto-optical disk, or the like, for example. Then, the information processing apparatus 10 reads the program from the recording medium, forwards it to an internal storage device or an external storage device, and stores and uses it. Furthermore, the program may be recorded in a storage device (recording medium) such as a magnetic disk, an optical disc, a magneto-optical disk, or the like, and may be provided to the computer via a communication route, for example.

At the time of implementing the functions as the first input unit 101, the first specific situation determination unit 102, the first behavior extraction unit 103, the specific situation behavior storage processing unit 104, the second input unit 106, the second specific situation determination unit 107, the second behavior extraction unit 111, the behavior comparison unit 112, and the evaluation unit 113, the program stored in the internal storage device (memory 12) is executed by the microprocessor (processor 11) of the computer. At this time, the computer may read and execute the program recorded in the recording medium.

The memory 12 is a storage memory including a read only memory (ROM) and a random access memory (RAM). In the ROM of the memory 12, a software program for operating the information processing apparatus 10 and data for this program are written. The software program in the memory 12 is appropriately read and executed by the processor 11. Furthermore, the RAM of the memory 12 is used as a primary storage memory or a working memory.

The storage device 13 is a storage device such as a hard disk drive (HDD), a solid state drive (SSD), a storage class memory (SCM), or the like, and stores software programs and various types of data.

In the example illustrated in FIG. 1, the determination program is stored in the storage device 13, and this determination program is executed by the processor 11 after being loaded to the RAM of the memory 12. Furthermore, the storage device 13 may store information included in the database group 105. The database group 105 includes a plurality of databases.

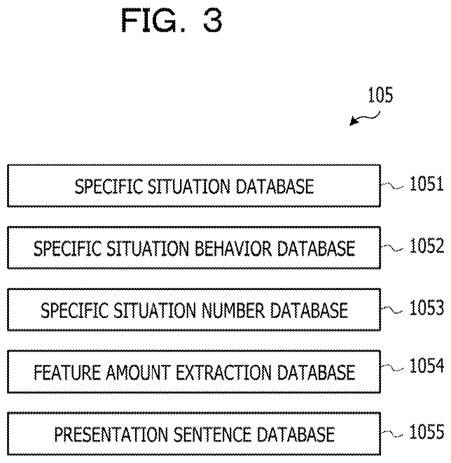

FIG. 3 is a diagram exemplifying the plurality of databases included in the database group 105 in the computer system 1 as an example of the first embodiment.

In the example illustrated in FIG. 3, the database group 105 includes a specific situation database 1051, a specific situation behavior database 1052, a specific situation number database 1053, a feature amount extraction database 1054, and a presentation sentence database 1055. Details of those specific situation database 1051, specific situation behavior database 1052, specific situation number database 1053, feature amount extraction database 1054, and presentation sentence database 1055 will be described later. Furthermore, a database may be referred to as a DB. The DB is an abbreviation for a database.

The memory 12 and the storage device 13 may store data and the like generated by the first input unit 101, the first specific situation determination unit 102, the first behavior extraction unit 103, the specific situation behavior storage processing unit 104, the second input unit 106, the second specific situation determination unit 107, the second behavior extraction unit 111, the behavior comparison unit 112, and the evaluation unit 113 in the process of executing the individual processing.

The display 17 is a display device that displays various types of information, which is, for example, a liquid crystal display device or a cathode ray tube (CRT) display device. In the present computer system 1, the video of the caller transmitted from the interlocutor terminal 2 is displayed on this display 17. In the present first embodiment, an exemplary case where the video is a moving image (video image) is described. The video includes voice.

Furthermore, a message (presentation sentence) or the like output from the evaluation unit 113 is displayed on the display 17.

The mouse 16 and the keyboard 15 are input devices operated by the receiver to perform various inputs.

As illustrated in FIG. 2, the information processing apparatus 10 has functions as the first input unit 101, the first specific situation determination unit 102, the first behavior extraction unit 103, the specific situation behavior storage processing unit 104, the second input unit 106, the second specific situation determination unit 107, the second behavior extraction unit 111, the behavior comparison unit 112, and the evaluation unit 113.

Of those, the first input unit 101, the first specific situation determination unit 102, the first behavior extraction unit 103, and the specific situation behavior storage processing unit 104 carry out pre-processing using the video (video data) of the remote conversation previously performed between the caller and the receiver. Hereinafter, the video data may be simply referred to as video. The video data includes voice data. Furthermore, the voice data may be simply referred to as voice.

Furthermore, the second input unit 106, the second specific situation determination unit 107, the second behavior extraction unit 111, the behavior comparison unit 112, and the evaluation unit 113 carry out real-time processing using the video of the remote conversation in progress (in the remote conversation) between the caller and the receiver.

The first input unit 101 obtains the video of the previous remote conversation performed between the caller and the receiver. This video includes video of the caller and video of the receiver. The first input unit 101 may obtain the video of the previous remote conversation by reading the video data of the previous remote conversation stored in the storage device 13, for example.

The video data of the remote conversation performed in the past corresponds to first sensing data including either video or voice generated in a first remote call made between the caller (first account) and the receiver (second account).

The first input unit 101 corresponds to an input unit that receives the first sensing data (past video data).

The first specific situation determination unit 102 determines a situation (specific situation) between the caller and the receiver in the video on the basis of the video of the previous remote conversation obtained by the first input unit 101. For example, the first specific situation determination unit 102 determines the past specific situation. The first specific situation determination unit 102 determines the specific situation especially for the caller in the video.

For example, the first specific situation determination unit 102 detects a specific phrase from the voice of the caller by voice recognition processing. In the voice recognition processing, for example, feature amount extraction processing is performed on the voice of the caller, and a phrase is detected from the voice of the caller on the basis of the extracted feature amount. Note that various existing methods may be used for those processes of detecting a phrase from the voice of the caller, and descriptions thereof will be omitted.

The specific phrase detected by the first specific situation determination unit 102 is a phrase indicating a situation of a speaker who has uttered the phrase during the remote conversation. In the present first embodiment, the caller corresponds to the speaker.

For example, the phrase “I am happy” indicates that the speaker is in a happy situation (specific situation). Furthermore, the phrase “I am in trouble” indicates that the speaker is in a troublesome situation, and the phrase “I am thinking” indicates that the speaker is in a situation of being nervous. Hereinafter, a specific phrase indicating that the speaker is in a specific state may be referred to as a specific phrase.

The first specific situation determination unit 102 associates the phrase (specific phrase) with the specific situation indicated by the specific phrase. This association may be carried out by, for example, referring to information in which the phrase and the specific situation are associated with each other in advance.

When the first specific situation determination unit 102 detects the specific phrase in the video of the remote conversation, it collects pieces of information related to the situation indicated by the specific phrase.

For example, the first specific situation determination unit 102 collects the time at which the specific phrase is detected (start time) and the time at which the detection of the specific phrase ends (end time). The first specific situation determination unit 102 may obtain, for example, the time (start time) and the time (end time) at which the detection of the specific phrase ends by referring to a time stamp of the frame in which the specific phrase is detected.

Furthermore, the first specific situation determination unit 102 recognizes a facial expression of the caller using an existing video recognition processing method. For example, the first specific situation determination unit 102 recognizes the facial expression of the caller who has uttered the phrase when the specific phrase is detected.

The first specific situation determination unit 102 extracts a video recognition feature amount, and recognizes the facial expression of the caller on the basis of the extracted video recognition feature amount. Note that the facial expression recognition may be carried out using various existing methods, and detailed descriptions thereof will be omitted.

Then, when the first specific situation determination unit 102 recognizes that the speaker has uttered a specific phrase, it stores, in the specific situation database 1051, the specific phrase (phrase), the specific situation indicated by the specific phrase, information (facial expression) indicating the recognized facial expression, the start time, and the end time in association with each other.

Furthermore, the first specific situation determination unit 102 detects a specific facial expression from the video of the caller by facial expression recognition processing. The specific facial expression detected by the first specific situation determination unit 102 is a facial expression indicating a situation of the speaker with the facial expression during the remote conversation.

For example, the facial expression “smiling” indicates that the speaker is in a happy situation (specific situation). Furthermore, the facial expression “unhappy” indicates that the speaker is in a troublesome situation, and the facial expression “stiff” indicates that the speaker is in a situation of being nervous. Hereinafter, a specific facial expression indicating that the speaker is in a specific state may be referred to as a specific facial expression.

The first specific situation determination unit 102 associates a facial expression (specific facial expression) with the specific situation indicated by the specific facial expression. This association may be carried out by, for example, referring to information in which the facial expression and the specific situation are associated with each other in advance.

When the first specific situation determination unit 102 detects the specific facial expression of the caller in the video of the remote conversation, it collects pieces of information related to the situation indicated by the specific facial expression.

For example, the first specific situation determination unit 102 collects the time at which the specific facial expression is detected (start time) and the time at which the detection of the specific facial expression ends (end time).

Then, when the first specific situation determination unit 102 recognizes a specific facial expression of the speaker, it stores, in the specific situation database 1051, the specific facial expression (facial expression), the specific situation indicated by the specific facial expression, the start time, and the end time in association with each other. A time period (time frame) specified by a combination of the start time and the end time of the specific situation in the first specific situation determination unit 102 may be referred to as a specific situation detection time period.

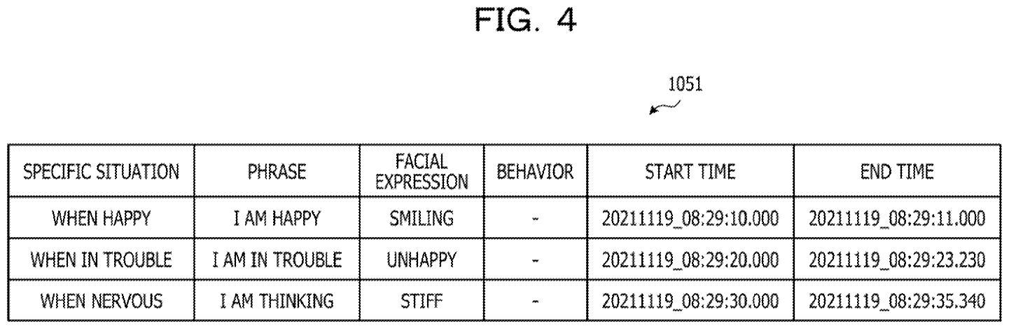

FIG. 4 is a diagram exemplifying the specific situation database 1051 in the computer system 1 as an example of the first embodiment.

In the specific situation database 1051 exemplified in FIG. 4, a specific situation, a phrase, a facial expression, behavior, start time, and end time are associated with each other. In the behavior, behavior extracted by the first behavior extraction unit 103 to be described later may be stored.

By referring to this specific situation database 1051, it becomes possible to grasp the time at which a specific phrase of the caller is detected, the specific situation indicated by the specific phrase, and the like.

Note that, while a phrase (specific phrase) and a facial expression (specific facial expression) are registered in each entry of the specific situation database 1051 exemplified in FIG. 4, it is not limited to this. Either the phrase (specific phrase) or the facial expression (specific facial expression) may be omitted.

The first specific situation determination unit 102 detects occurrence of a specific situation in the video of the previous remote conversation, and records it in the specific situation database 1051.

The first specific situation determination unit 102 performs the detection of specific situation occurrence and the recordation in the specific situation database 1051 on video of all of a plurality of previous remote conversations obtained by the first input unit 101.

Furthermore, the first specific situation determination unit 102 extracts feature points in the video in the specific situation detection time period in frame units, and records them in the feature amount extraction database 1054.

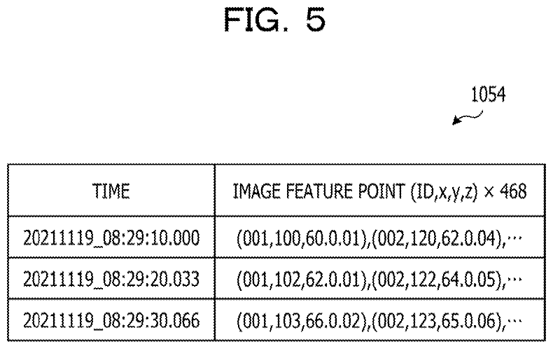

FIG. 5 is a diagram exemplifying the feature amount extraction database 1054 in the computer system 1 as an example of the first embodiment.

In the feature amount extraction database 1054 exemplified in FIG. 5, time of a frame in the specific situation detection time period and an image feature point extracted from the frame are associated with each other.

Furthermore, the first specific situation determination unit 102 may extract voice feature points in the video (voice) in the specific situation detection time period in frame units, and may record them in the feature amount extraction database 1054.

The information (image feature point and voice feature point) registered in the feature amount extraction database 1054 is used for, for example, detection of the specific situation behavior of the caller by the first behavior extraction unit 103.

The first behavior extraction unit 103 detects, from the video of the previous remote conversation, characteristic behavior of the caller in each specific situation detection time period or in a time period of a part of the specific situation detection time period on the basis of the individual specific situations recorded in the first specific situation determination unit 102. The characteristic behavior detected in the specific situation detection time period may be referred to as specific situation behavior.

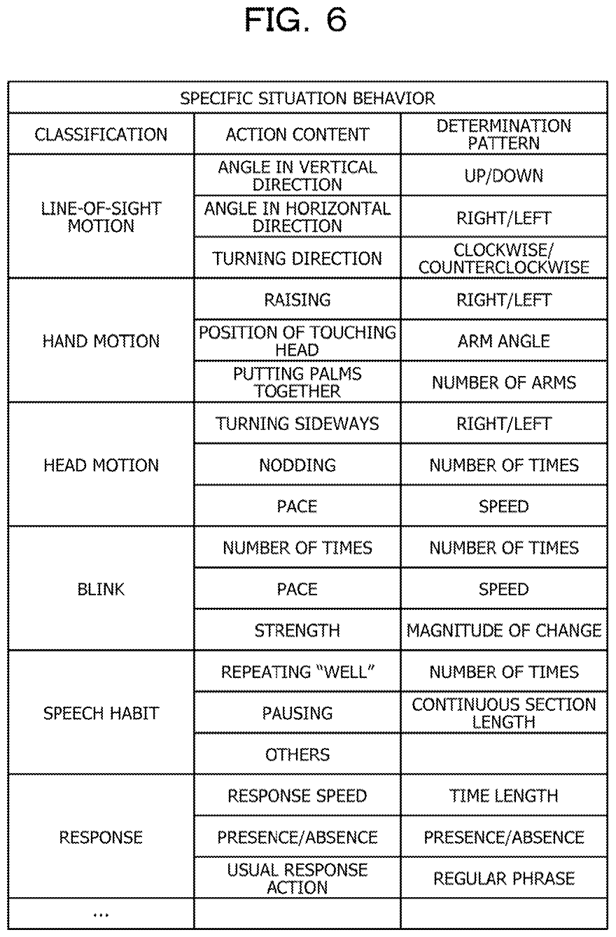

FIG. 6 is a diagram exemplifying the specific situation behavior in the computer system 1 as an example of the first embodiment.

The information indicating the specific situation behavior exemplified in FIG. 6 includes classification, action content, and a determination pattern.

The classification is classification of behavior, and indicates, for example, an object to be focused on when the first behavior extraction unit 103 and the second behavior extraction unit 111 to be described later detect the behavior.

The action content indicates contents of behavior detected by the first behavior extraction unit 103 for the target indicated in the classification. The action content indicates characteristic action content commonly observed in a specific situation. The first behavior extraction unit 103 and the second behavior extraction unit 111 detect an action corresponding to the action content.

The determination pattern indicates, for example, determination conditions for detecting the action indicated in the action content. The first behavior extraction unit 103 and the second behavior extraction unit 111 determine whether the action indicated in the action content satisfies the determination conditions indicated in the determination pattern.

Note that, while characters such as speed, number, and the like are indicated in the example illustrated in FIG. 6 for convenience, a specific numerical value to serve as a threshold value may be set in practice.

Furthermore, the determination pattern may be contents (sub-determination conditions) collaterally determined when the action indicated in the action content is detected.

For example, with regard to motion of a line of sight, it is indicated that the first behavior extraction unit 103 and the second behavior extraction unit 111 determine a method of moving the line of sight (up/down/right/left) in addition to an angle at which the line of sight has moved.

The first behavior extraction unit 103 may determine the determination pattern using a detection position, the number of times, and the like. For example, whether it is on the right side or the left side may be determined using a detected hand position. The first behavior extraction unit 103 and the second behavior extraction unit 111 also detect this determination pattern.

Note that the determination pattern may be omitted depending on the action content.

For example, the first behavior extraction unit 103 extracts the feature amount of the video using an existing video recognition method, and detects the specific situation behavior on the basis of the extracted feature amount.

The first behavior extraction unit 103 extracts, by image recognition, the feature amount (image feature points) from the video data in the specific situation detection time period in the video of the previous remote conversation.

The first behavior extraction unit 103 detects the specific situation behavior on the basis of the image feature points and the voice feature points. The first behavior extraction unit 103 carries out, for example, detection of head motion, detection of hand motion, detection of a blink, detection of motion of the line of sight, and the like on the basis of the image feature points.

The first behavior extraction unit 103 detects, on the basis of the voice feature points, behavior such as a speech habit of the caller, a response, and the like by, for example, voice recognition processing.

Furthermore, the first behavior extraction unit 103 may detect the head motion and the blink from a change in feature amount coordinates of the face by video recognition. Furthermore, the first behavior extraction unit 103 may detect the motion of the line of sight from the line-of-sight detection. Moreover, the first behavior extraction unit 103 may detect the behavior such as the hand motion by gesture recognition.

Furthermore, for example, the first behavior extraction unit 103 extracts the feature amount of the voice included in the video using an existing video recognition method, and detects the specific situation behavior on the basis of the extracted feature amount.

Those kinds of detection of the specific situation behavior may be carried out by an existing method, and detailed descriptions thereof will be omitted.

The first behavior extraction unit 103 extracts, by voice recognition, the feature amount (voice feature points) from the voice data in the specific situation detection time period in the video of the previous remote conversation.

The first behavior extraction unit 103 performs, for example, speech habit detection, response detection, and the like on the basis of the voice feature points. Those kinds of detection of the specific situation behavior may be carried out by an existing method, and descriptions thereof will be omitted.

The first behavior extraction unit 103 stores information regarding the specific situation behavior extracted from the video of the previous remote conversation performed between the caller and the receiver in a predetermined storage area of the memory 12 or the storage device 13. The information regarding the specific situation behavior includes the determination patterns.

Furthermore, the first behavior extraction unit 103 stores and manages the number of the specific situation behaviors detected from the video data of the remote conversation with the caller in the specific situation number database 1053.

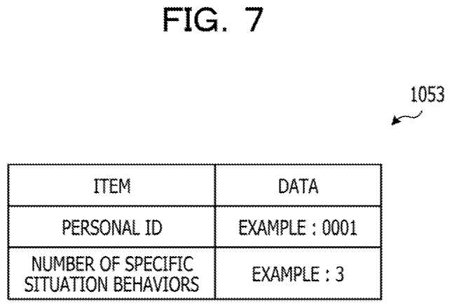

FIG. 7 is a diagram exemplifying the specific situation number database 1053 in the computer system 1 as an example of the first embodiment.

The specific situation number database 1053 exemplified in FIG. 7 includes personal identification (ID) and the number of specific situation behaviors as items, and data is stored in association with each of those items.

The personal ID is identification information for identifying the caller, and “0001” is set in the example illustrated in FIG. 7.

The number of specific situation behaviors indicates the number of specific situation behaviors detected by the first behavior extraction unit 103 from the video data of the previous remote conversation for the caller identified by the personal ID.

Note that the first behavior extraction unit 103 may obtain the voice feature points and the image feature points in the specific situation detection time period from the feature amount extraction database 1054.

When the first behavior extraction unit 103 detects that a specific situation for the caller has occurred on the basis of the first sensing data (past video data) and second sensing data (real-time video data), it refers to the specific situation behavior database 1052 for the behavior and the determination pattern (feature information). Then, the first behavior extraction unit 103 identifies the feature information (behavior and determination pattern) associated with the specific situation that has occurred. For example, the first behavior extraction unit 103 corresponds to a feature information specifying unit.

The specific situation behavior storage processing unit 104 determines the most frequent specific situation behavior for each specific situation on the basis of a plurality of specific situation behaviors extracted by the first behavior extraction unit 103.

For example, the specific situation behavior storage processing unit 104 determines a characteristic behavior corresponding to each specific situation.

Then, the specific situation behavior storage processing unit 104 records information regarding the specific situation behavior for each specific situation in the specific situation behavior database 1052.

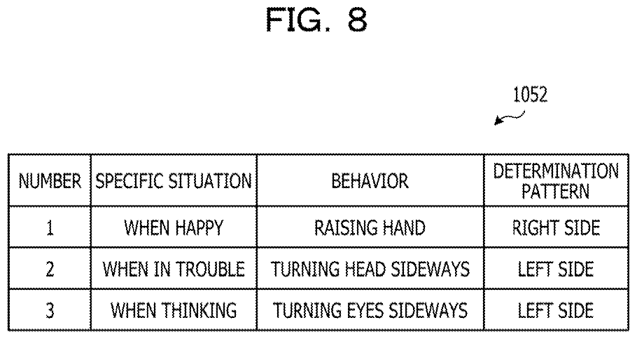

FIG. 8 is a diagram exemplifying the specific situation behavior database 1052 in the computer system 1 as an example of the first embodiment.

In the specific situation behavior database 1052 exemplified in FIG. 8, a number, a specific situation, behavior, and a determination pattern are associated with each other.

The behavior represented by the caller most frequently in the specific situation detected in the previous remote conversation is registered in the specific situation behavior database 1052. Therefore, it becomes possible to grasp the behavior represented by the caller in the specific situation by referring to the specific situation behavior database 1052.

The specific situation behavior database 1052 corresponds to a storage unit that stores the feature information (behavior and determination pattern) extracted when a particular situation (specific situation) for the caller occurs in the video data (first sensing data) of the previous remote conversation.

The specific situation behavior storage processing unit 104 may carry out matching processing with a predefined behavior for all detected behaviors (phrase, facial expression, etc.), and when a behavior with a matching score equal to or higher than a first threshold value TH1 appears at a frequency of equal to or more than a second threshold value TH2, it may determine the behavior as a behavior pattern of the specific situation.

The second input unit 106 obtains the video of the ongoing remote conversation (being performed in real time) between the caller and the receiver. This video includes video of the caller and video of the receiver. The video of the remote conversation performed between the caller and the receiver is generated by, for example, a program that implements the remote call between the information processing apparatus 10 and the interlocutor terminal 2, and is stored in, for example, a predetermined storage area of the memory 12 or the storage device 13. The second input unit 106 may obtain the video of the remote conversation by reading this stored video data of the remote conversation.

The video data of the ongoing remote conversation (being performed in real time) between the caller and the receiver corresponds to the second sensing data including either video or voice generated in a second remote call made between the caller (first account) and the receiver (second account).

The second input unit 106 corresponds to an input unit that receives the second sensing data (real-time video data).

The second specific situation determination unit 107 determines a situation (specific situation) between the caller and the receiver in the video on the basis of the video of the remote conversation being performed in real time (currently in progress) obtained by the second input unit 106. The remote conversation being performed in real time (currently in progress) may be referred to as a current remote conversation. Furthermore, a specific situation detected from the current remote conversation may be referred to as a current specific situation.

The second specific situation determination unit 107 determines the current specific situation. The second specific situation determination unit 107 determines the specific situation especially for the caller in the video.

The second specific situation determination unit 107 compares the detected current specific situation with the specific situation detected in the previous remote conversation, and carries out a process for generating specific situations until the number of detected current specific situations reaches the number of specific situations detected in the past.

As illustrated in FIG. 2, the second specific situation determination unit 107 has functions as a specific situation monitoring unit 108, a specific situation number calculation unit 109, and a specific situation creation unit 110.

The specific situation monitoring unit 108 detects, using a method similar to the first specific situation determination unit 102, occurrence of the specific situation from the video of the remote conversation being performed in real time obtained by the second input unit 106.

For example, the specific situation monitoring unit 108 detects a specific phrase from the voice of the caller in the video during the remote call by voice recognition processing. Furthermore, when the specific situation monitoring unit 108 detects the specific phrase in the video of the remote conversation, it collects pieces of information related to the situation indicated by the specific phrase. The specific situation monitoring unit 108 associates a specific phrase with a specific situation.

Furthermore, the specific situation monitoring unit 108 detects a specific facial expression from the video of the caller by facial expression recognition processing. Furthermore, when the specific situation monitoring unit 108 detects the specific facial expression of the caller in the video of the remote conversation, it collects pieces of information related to the situation indicated by the specific facial expression. The specific situation monitoring unit 108 associates a specific facial expression with a specific situation.

The specific situation monitoring unit 108 refers to the specific situation behavior database 1052 on the basis of the detected specific situation (specific situation comparison), and checks whether a specific situation that matches the detected specific situation is registered in the specific situation behavior database 1052.

The specific situation monitoring unit 108 may carry out, for example, text matching to check whether a specific situation that matches the detected specific situation is registered in the specific situation behavior database 1052. For example, the specific situation monitoring unit 108 carries out text matching for the specific situation registered in the specific situation behavior database 1052 using a word indicating the detected specific situation (e.g., when happy), and determines registration when being matched.

In a case where a specific situation that matches the detected specific situation is registered in the specific situation behavior database 1052, the specific situation monitoring unit 108 stores information indicating the specific situation in a predetermined storage area of the memory 12, the storage device 13, or the like.

When the elapsed time of the ongoing remote conversation reaches or exceeds a predetermined time (designated time T1) set in advance, the specific situation monitoring unit 108 detects occurrence of the specific situation in the video of the remote conversation. This makes it possible to reduce the load on the present information processing apparatus 10.

The specific situation number calculation unit 109 calculates the number of specific situations (specific situation number) created by the specific situation creation unit 110 to be described later on the basis of the specific situation that the specific situation monitoring unit 108 has successfully determined within a predetermined period of time and the specific situations registered in the specific situation behavior database 1052.

The specific situation number calculation unit 109 subtracts the number of specific situations (number of determined specific situations) detected (determined) by the specific situation monitoring unit 108 from the number of all specific situations (total number of specific situations) registered in the specific situation behavior database 1052, thereby obtaining the number of (required) specific situations (number of specific situations required to be created) to be created by the specific situation creation unit 110.

The specific situation creation unit 110 carries out a process of generating (creating) a specific situation. For example, the specific situation creation unit 110 may ask or guide the other party to take the expected behavior.

Here, the behavior of the caller taken in the specific situation may be, for example, talking happily in a specific situation where a certain geographical name appears in the conversation while keeping silent at other times, getting upset when the same story is repeated 10 times or more while being patient when repeated only two or three times, or the like.

Furthermore, the behavior of the caller may be, for example, turning the head sideways when being in trouble, raising the left hand when being happy, or the like.

The specific situation creation unit 110 may cause the receiver to ask the caller a question that causes the caller to behave as expected.

The question has multiple interpretations (right/left, up/down, etc.), and the characteristic behavior of the caller differs depending on the specific situation (how to turn the head sideways when being in trouble, or how to raise the hand when being happy).

The specific situation creation unit 110 may guide the other party to take the expected behavior. For example, the specific situation creation unit 110 may guide the receiver to say a geographical name that the other party is interested in to create a situation where the caller talks, or may guide the receiver to repeat the same story 10 times or more to create a situation where the other party gets upset.

In the present computer system 1, questions to be asked by the receiver to the caller and presentation sentences for guiding the receiver are prepared in advance in association with a plurality of types of specific situations to generate the specific situations, and are recorded in the presentation sentence database 1055.

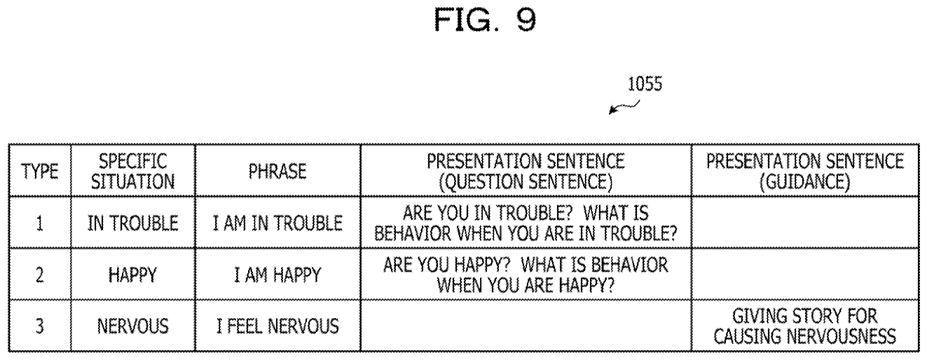

FIG. 9 is a diagram exemplifying the presentation sentence database 1055 in the computer system 1 as an example of the first embodiment.

In the presentation sentence database 1055 exemplified in FIG. 9, a phrase is associated with a specific situation, and a presentation sentence (question sentence) or a presentation sentence (guidance) is also associated with the specific situation. Furthermore, unique identification information (type) indicating a type of a specific situation is associated with each specific situation. In the example illustrated in FIG. 9, a natural number is set as a type.

The presentation sentence (question sentence) is a question sentence considered to be effective to generate the corresponding specific situation when the receiver asks it to the caller. The presentation sentence (guidance) is an advice sentence (guidance sentence) suggesting an action considered to be effective to generate the corresponding specific situation when the receiver takes it for the caller.

In FIG. 9, for example, the phrase “I am happy” and the presentation sentence (question sentence) “Are you happy? What is the behavior when you are happy?” are registered for the specific situation “being happy”.

Furthermore, the phrase “I feel nervous” and the presentation sentence (guidance) “Giving a story for causing nervousness” is registered for the specific situation “being nervous”.

The presentation sentences registered in the presentation sentence database 1055 may be automatically generated by the system, or may be set in advance by a user or the like. Furthermore, it is preferable that the presentation sentences may be optionally changed by the user (receiver). The specific situations and the presentation sentences are not limited to those exemplified in FIG. 9, and may be changed and implemented as appropriate.

The specific situation creation unit 110 executes processing of obtaining the number of specific situations, processing of specific situation screen presentation, processing of specific situation creation, processing of specific situation phrase detection, and processing of specific situation recordation.

With regard to the processing of obtaining the number of specific situations, the specific situation creation unit 110 obtains the number of specific situations calculated by the specific situation number calculation unit 109 at the timing when the designated time T1 is reached in the occurrence detection by the specific situation monitoring unit 108.

With regard to the processing of specific situation screen presentation, the specific situation creation unit 110 refers to the presentation sentence database 1055 to read, among the specific situations registered in the presentation sentence database 1055, specific situations of the number of specific situations other than the specific situations detected by the specific situation monitoring unit 108. The specific situation creation unit 110 causes the display 17 to display the presentation sentences of the number of those specific situations.

For example, the specific situation creation unit 110 causes the display 17 to display the presentation sentences of the number of those specific situations at the timing when the designated time T1 is reached in the occurrence detection by the specific situation monitoring unit 108.

Note that the specific situation creation unit 110 does not cause the presentation sentence corresponding to the specific situation in which the behavior is detected by the specific situation monitoring unit 108 to be displayed.

In the processing of specific situation creation, the receiver reads out the presentation sentence (question sentence and guidance sentence) displayed on the display 17, or speaks the question sentence and the guidance sentence according to the contents of the presentation sentence to the caller. It is preferable that the timing at which the receiver speaks the contents of the presentation sentence is decided by the receiver. Furthermore, the receiver may speak the contents of the presentation sentence at the timing when the phrase of the specific situation is included in the utterance of the caller.

In the processing of specific situation phrase detection, the specific situation creation unit 110 detects a phrase (specific situation phrase) included in the specific situation from the utterance of the caller. This detection of the specific situation phrase may be implemented by a method similar to the first specific situation determination unit 102 and the specific situation monitoring unit 108.

In the processing of specific situation recordation, the specific situation creation unit 110 stores information related to the specific situation corresponding to the detected specific situation phrase in a predetermined storage area of the memory 12, the storage device 13, or the like.

The information related to the specific situation corresponding to the detected specific situation phrase is preferably recorded in association with a specific situation, a phrase, a facial expression, behavior, start time, and end time in a similar manner to the specific situation database 1051 exemplified in FIG. 4.

Furthermore, the video related to the specific situation generated by the second specific situation determination unit 107 is stored in a predetermined storage area of the memory 12, the storage device 13, or the like.

The specific situation creation unit 110 corresponds to a specific situation creation unit that generates a particular situation (specific situation) for the caller by outputting presentation information (question sentence and guidance) to the receiver who makes the ongoing remote call (real-time video data).

In a case where the specific situation for the caller detected on the basis of the video data of the previous remote conversation is different (inconsistent) from the specific situation for the caller him/herself detected on the basis of the video data of the remote conversation in real time, the specific situation creation unit 110 generates a particular situation (specific situation) for the caller.

The second behavior extraction unit 111 detects characteristic behavior of the caller for the specific situation detected by the specific situation monitoring unit 108 and the specific situation generated by the second specific situation determination unit 107 from the video of the remote conversation being performed in real time.

The second behavior extraction unit 111 detects the characteristic behavior (specific situation behavior) of the caller using a method similar to the first behavior extraction unit 103. The specific situation behavior detected by the second behavior extraction unit 111 from the video data of the current remote conversation may be referred to as current specific situation behavior. The current specific situation behavior may include a determination pattern. The behavior and the determination pattern correspond to the feature information.

The second behavior extraction unit 111 detects, for each specific situation, a characteristic behavior of the caller in each specific situation detection time period or in a time period of a part of the specific situation detection time period.

The second behavior extraction unit 111 sets a time to detect the specific situation behavior (specific situation detection time frame T2) in advance, and detects the specific situation behavior within the specific situation detection time frame T2. This makes it possible to efficiently carry out the process without endlessly spending time to detect the specific situation behavior.

The second behavior extraction unit 111 stores information regarding the specific situation behavior extracted from the video of the previous remote conversation performed between the caller and the receiver in a predetermined storage area of the memory 12 or the storage device 13.

The behavior comparison unit 112 compares each current specific situation behavior extracted by the second behavior extraction unit 111 with the behaviors and the determination patterns registered in the specific situation behavior database 1052.

The behavior comparison unit 112 determines, for all the specific situations registered in the specific situation behavior database 1052, whether the specific situation behavior and the determination pattern match the specific situation behavior and the determination pattern with the corresponding specific situation among the specific situation behaviors extracted by the second behavior extraction unit 111.

The behavior comparison unit 112 compares the specific situation behavior detected by the first behavior extraction unit 103 with the specific situation behavior detected by the second behavior extraction unit 111.

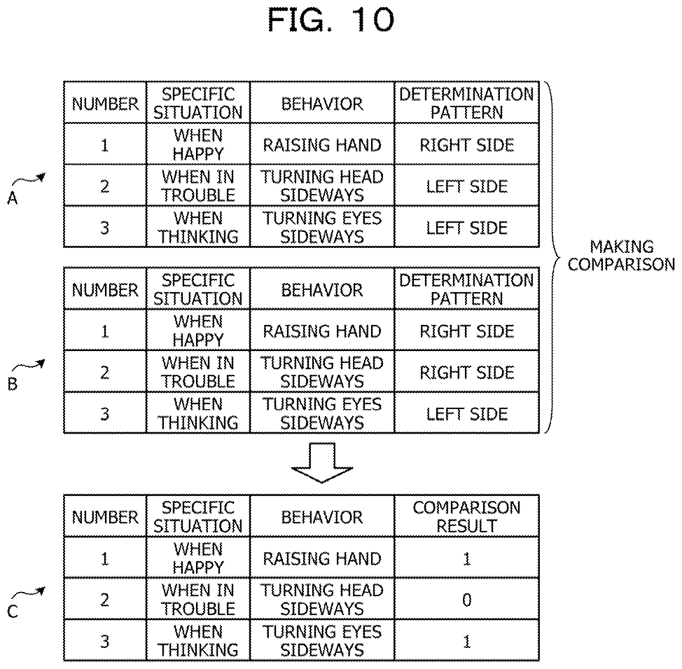

FIG. 10 is a diagram for explaining the processing by the behavior comparison unit 112 in the computer system 1 as an example of the first embodiment.

In the example illustrated in FIG. 10, a reference sign A indicates behaviors and determination patterns registered in the specific situation behavior database 1052, and a reference sign B indicates individual specific situation behaviors and determination patterns extracted by the second behavior extraction unit 111. Furthermore, a reference sign C indicates comparison results between the behaviors and determination patterns registered in the specific situation behavior database 1052 indicated by the reference sign A and the individual specific situation behaviors and determination patterns extracted by the second behavior extraction unit 111 indicated by the reference sign B. In the example indicated by the reference sign C in FIG. 9, a comparison result “1” indicates a matched state, and a comparison result “0” indicates an inconsistent state.

In the comparison results, the behavior comparison unit 112 compares the current specific situation behavior with the specific situation behavior database 1052, and sets “1” for the specific situation when they match, and sets “0” for the specific situation when they do not match, respectively.

In the example illustrated in FIG. 10, while the contents of the specific situations “when happy” and “when thinking” match, the determination patterns (sub-determination conditions) of “when in trouble” do not match with each other (see reference sign C).

The comparison results by the behavior comparison unit 112 are stored (accumulated and cumulated) in a predetermined storage area of the memory 12 or the storage device 13.

The evaluation unit 113 evaluates a spoofing level of the caller in the video of the ongoing remote conversation between the caller and the receiver on the basis of the comparison results by the behavior comparison unit 112.

The evaluation unit 113 calculates a value representing the spoofing level (spoofing level evaluation value) on the basis of the comparison results by the behavior comparison unit 112.

For example, the evaluation unit 113 calculates, as a spoofing level evaluation value, a ratio between all comparison numbers of all the specific situation behaviors registered in the specific situation behavior database 1052 and the specific situation behaviors extracted by the second behavior extraction unit 111 and the number of inconsistent cases in the comparison results. The spoofing level evaluation value may be referred to as a spoofing level.

As a process of making determination related to spoofing, the evaluation unit 113 calculates an index value (spoofing level evaluation value) for determining spoofing on the basis of the number of matches between the behavior and determination pattern (feature information) in the specific situation extracted from the video data of the previous remote conversation and the behavior and determination pattern in the specific situation extracted from the video data of the remote conversation being performed in real time.

The evaluation unit 113 corresponds to a determination unit that makes determination related to spoofing on the basis of a matching state between the behavior and determination pattern (feature information) in the specific situation in the specific situation behavior database 1052 (storage unit) and the behavior and determination pattern (feature information) in the specific situation detected from the video data (second sensing data) of the remote conversation currently in progress.

The evaluation unit 113 causes the display 17 to display (output) the calculated spoofing level evaluation value (spoofing level), thereby making notification to the receiver. At this time, the evaluation unit 113 may make the notification to the receiver by causing the display 17 to display (output) all the comparison results between the specific situation behaviors registered in the specific situation behavior database 1052 and the specific situation behaviors extracted by the second behavior extraction unit 111.

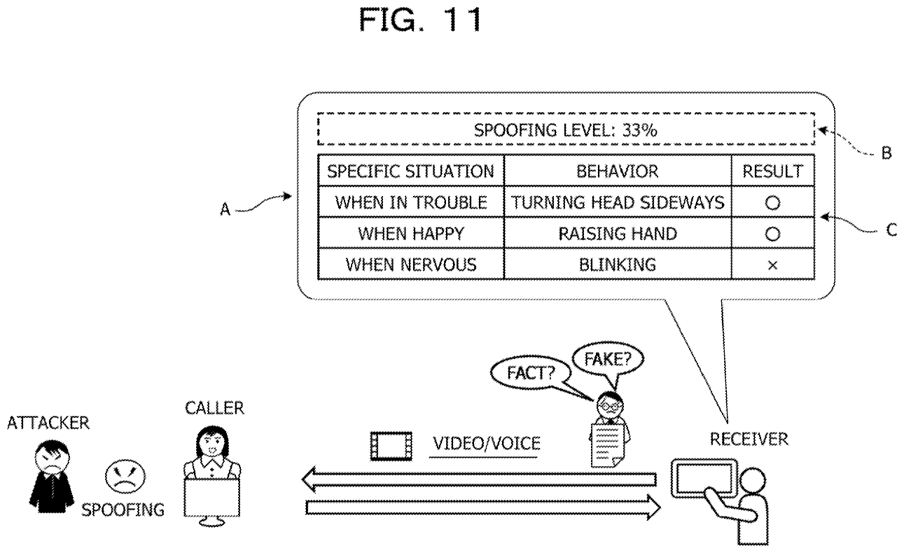

FIG. 11 is a diagram exemplifying an output image of a spoofing detection result in the computer system 1 as an example of the first embodiment.

In FIG. 11, a reference sign A indicates an exemplary spoofing detection result displayed on the display 17 of the information processing apparatus 10 of the receiver.

The spoofing detection result exemplified in FIG. 11 includes a spoofing level (see reference sign B) and a comparison result of the specific situation behavior in each specific situation (see reference sign C). Note that the comparison result is indicated by O or X in FIG. 11.

The receiver is enabled to know that an attacker may be impersonating the caller by viewing the spoofing detection results displayed on the display 17 in this manner. The receiver may take measures such as stopping the remote conversation, deterring the conversation of highly confidential information in the remote call, and the like.

(B) Operation

In the present computer system 1, the specific situation monitoring unit 108 monitors a specific situation that has occurred in the past or the specific situation creation unit 110 generates the specific situation during the interaction of the remote conversation between the caller and the receiver. Then, the behavior comparison unit 112 and the evaluation unit 113 detect spoofing using the behavior pattern of the other party taken in a similar specific situation in the past.

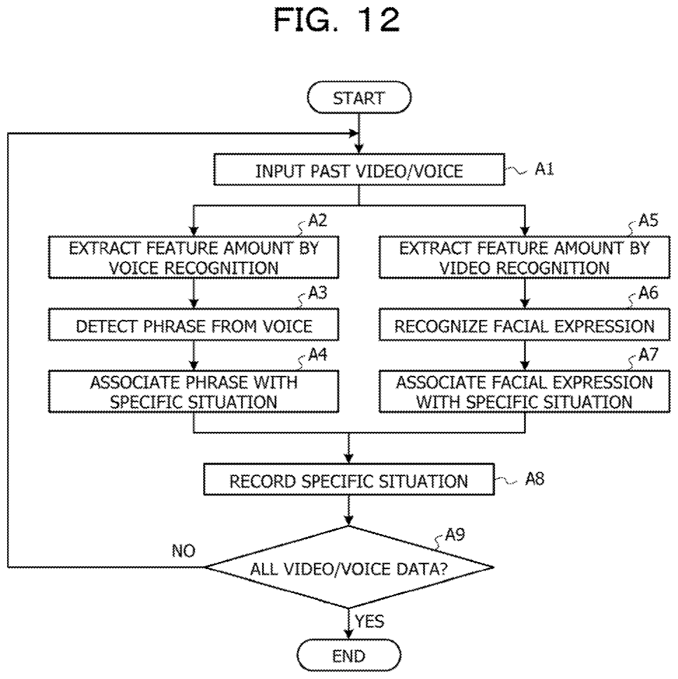

A process of the first specific situation determination unit 102 in the computer system 1 as an example of the first embodiment configured as described above will be described with reference to a flowchart (steps A1 to A9) illustrated in FIG. 12.

In step A1, the video of the previous remote conversation performed between the caller and the receiver is input to the information processing apparatus 10, and this video is obtained. The first specific situation determination unit 102 processes this recorded video data of the remote conversation performed in the past.

In step A2, the first specific situation determination unit 102 performs the feature amount extraction processing on the voice of the caller by voice recognition processing.

In step A3, the first specific situation determination unit 102 detects a phrase from the voice of the caller on the basis of the extracted feature amount.

In step A4, the first specific situation determination unit 102 identifies the specific situation indicated by the phrase (specific phrase), and associates the phrase (specific phrase) with the identified specific situation. Thereafter, the process proceeds to step A8.

Furthermore, the process of steps A5 to A7 is carried out in parallel with the process of steps A2 to A4 described above.

In step A5, the first specific situation determination unit 102 performs the feature amount extraction processing on the video of the caller by video recognition processing.

In step A6, the first specific situation determination unit 102 carries out facial expression recognition of the caller on the basis of the extracted feature amount.

In step A7, the first specific situation determination unit 102 identifies the specific situation indicated by the facial expression (specific facial expression), and associates the facial expression (specific facial expression) with the identified specific situation. Thereafter, the process proceeds to step A8.

In step A8, the first specific situation determination unit 102 stores, in the specific situation database 1051, the specific situation in association with the recognized specific phrase (phrase), the information indicating the recognized facial expression (facial expression), start time, and end time.

In step A9, the first specific situation determination unit 102 checks whether all video (voice) data of the previous remote conversation has been processed. If there is no unprocessed video as a result of the checking (see No route in step A9), the process returns to step A1. On the other hand, if all the video (voice) data has been processed (see YES route in step A9), the process is terminated.

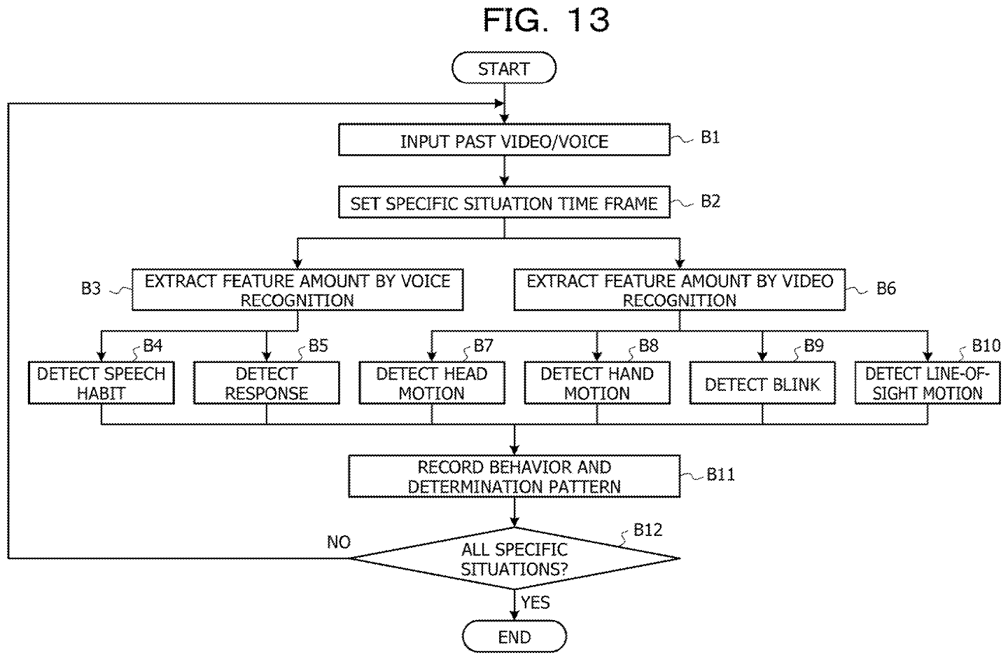

Next, a process of the first behavior extraction unit 103 in the computer system 1 as an example of the first embodiment will be described with reference to a flowchart (steps B1 to B12) illustrated in FIG. 13.

In step B1, the video data of the previous remote conversation is input to the first behavior extraction unit 103.

In step B2, the first behavior extraction unit 103 refers to the specific situation database 1051 to obtain the time frame (specific situation detection time period) in which the specific situation is detected, and obtains (sets) the video of this specific situation detection time period.

In step B3, the first behavior extraction unit 103 extracts, by voice recognition, the feature amount (voice feature points) from the voice data in the specific situation detection time period in the video of the previous remote conversation. Thereafter, the process proceeds to steps B4 and B5. The first behavior extraction unit 103 may obtain an information extraction model of the feature amount from the feature amount extraction database 1054.

In step B4, the first behavior extraction unit 103 performs speech habit detection on the basis of the voice feature points.

In step B5, the first behavior extraction unit 103 performs response detection on the basis of the voice feature points.

Furthermore, the process of steps B6 to B10 is carried out in parallel with the process of steps B3 to B5 described above.

In step B6, the first behavior extraction unit 103 extracts, by image recognition, the feature amount (image feature points) from the video data in the specific situation detection time period in the video of the previous remote conversation. Here, the first behavior extraction unit 103 may obtain the information extraction model of the feature amount from the feature amount extraction database 1054. Thereafter, the process proceeds to steps B7 to B10.

In step B7, the first behavior extraction unit 103 performs head motion detection on the basis of the image feature points.

In step B8, the first behavior extraction unit 103 performs hand motion detection on the basis of the image feature points.

In step B9, the first behavior extraction unit 103 performs blink detection on the basis of the image feature points.

In step B10, the first behavior extraction unit 103 performs line-of-sight motion detection on the basis of the image feature points.

Thereafter, in step B11, the first behavior extraction unit 103 stores information regarding the detected specific situation behavior and the determination pattern in a predetermined storage area of the memory 12 or the storage device 13.

In step B12, the first behavior extraction unit 103 checks whether the specific situation behavior and the determination pattern have been extracted for all the specific situations. As a result of the checking, if there is a specific situation for which the specific situation behavior and the determination pattern have not been extracted (see NO route in step B12), the process returns to step B1.

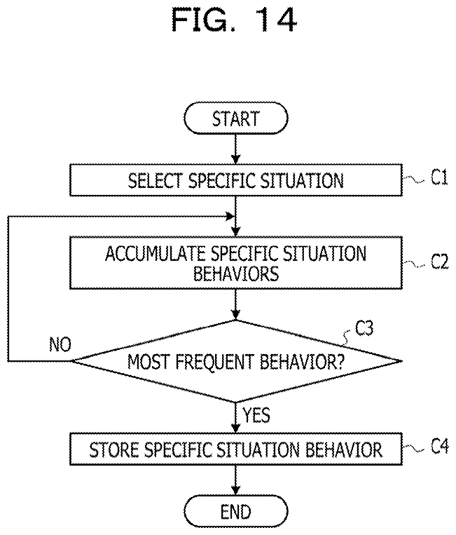

Furthermore, if the specific situation behavior and the determination pattern have been extracted for all the specific situations (see YES route in step B12), the process is terminated. The process proceeds to a process by the specific situation behavior storage processing unit 104 illustrated in FIG. 14.

Next, the process of the specific situation behavior storage processing unit 104 in the computer system 1 as an example of the first embodiment will be described with reference to a flowchart (steps C1 to C4) illustrated in FIG. 14.

In step C1, the specific situation behavior storage processing unit 104 selects one specific situation from a plurality of specific situations registered in the specific situation database 1051.

In step C2, the specific situation behavior storage processing unit 104 checks the accumulated value (frequency) of the number of times of detection of the behavior extracted by the first behavior extraction unit 103 for the selected specific situation.

In step C3, the specific situation behavior storage processing unit 104 checks whether the accumulated value of the number of times of detection of the behavior is the largest, which is, whether the behavior appears most frequently in the specific situation. If it is not the most frequent behavior as a result of the checking (see NO route in step C3), the process returns to step C2 and selects another behavior.

Furthermore, if it is the most frequent behavior as a result of the checking (see YES route in step C3), the process proceeds to step C4. In step C4, the specific situation behavior storage processing unit 104 stores, in the specific situation behavior database 1052, the most frequent specific situation behavior in association with the specific situation. Thereafter, the process is terminated.

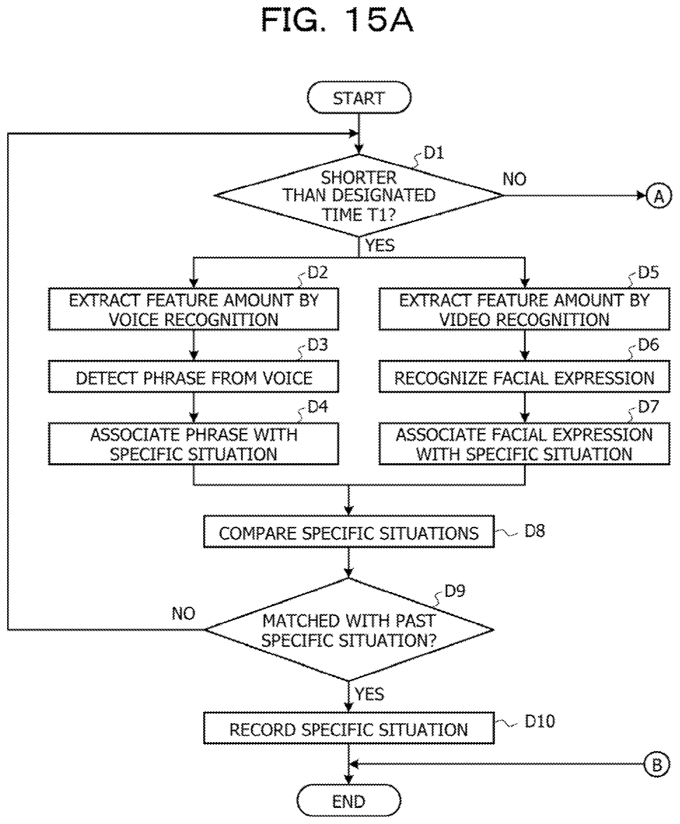

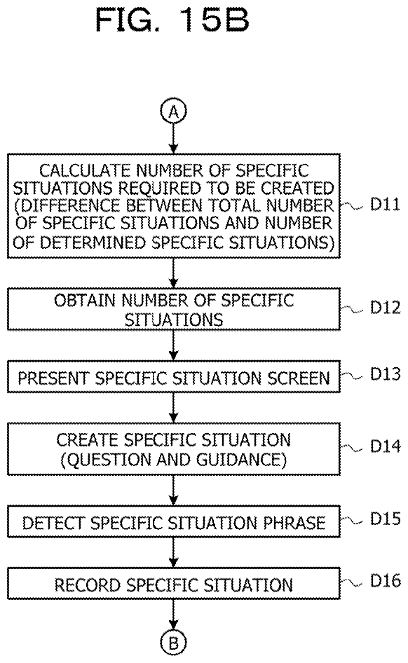

Next, a process of the second specific situation determination unit 107 in the computer system 1 as an example of the first embodiment will be described with reference to a flowchart (steps D1 to D16) illustrated in FIGS. 15A and 15B.

In the present process, the video data of the ongoing remote conversation is input to the second specific situation determination unit 107, and the second specific situation determination unit 107 processes the video data of the ongoing remote conversation.

In step D1, the second specific situation determination unit 107 checks whether the elapsed time of the ongoing remote conversation is shorter than the designated time T1.

If the elapsed time of the ongoing remote conversation is shorter than the designated time T1 (see YES route in step D1), the process proceeds to step D2.

In step D2, the specific situation monitoring unit 108 performs the feature amount extraction processing on the voice of the caller by voice recognition processing.

In step D3, the specific situation monitoring unit 108 detects a phrase from the voice of the caller on the basis of the extracted feature amount.

In step D4, the specific situation monitoring unit 108 identifies the specific situation indicated by the phrase (specific phrase), and associates the phrase (specific phrase) with the identified specific situation. Thereafter, the process proceeds to step D8

Furthermore, the process of steps D5 to D7 is carried out in parallel with the process of steps D2 to D4 described above.

In step D5, the specific situation monitoring unit 108 performs the feature amount extraction processing on the video of the caller by video recognition processing.

In step D6, the specific situation monitoring unit 108 carries out facial expression recognition of the caller on the basis of the extracted feature amount.

In step D7, the specific situation monitoring unit 108 identifies the specific situation indicated by the facial expression (specific facial expression), and associates the facial expression (specific facial expression) with the identified specific situation. Thereafter, the process proceeds to step D8

In step D8, the specific situation monitoring unit 108 refers to the specific situation behavior database 1052 on the basis of the detected specific situation (specific situation comparison), and checks whether a specific situation that matches the detected specific situation is registered in the specific situation behavior database 1052. The specific situation monitoring unit 108 checks whether the detected specific situation matches the specific situation registered in the specific situation behavior database 1052.

As a result of the checking, if the detected specific situation does not match the specific situation registered in the specific situation behavior database 1052 (see NO route in step D9), the process returns to step D1.

Furthermore, if the detected specific situation matches the specific situation registered in the specific situation behavior database 1052 (see YES route in step D9), the process proceeds to step D10.

In step D10, the specific situation monitoring unit 108 stores information indicating the detected specific situation in a predetermined storage area of the memory 12, the storage device 13, or the like. Thereafter, the process is terminated.

Furthermore, if the elapsed time of the ongoing remote conversation is equal to or more than the designated time T1 as a result of the checking in step D1 (see NO route in step D1), the process proceeds to step D11.

In step D11, the specific situation number calculation unit 109 subtracts the number of specific situations (number of determined specific situations) detected (determined) by the specific situation monitoring unit 108 from the number of all specific situations (total number of specific situations) registered in the specific situation behavior database 1052, thereby calculating the number of specific situations required to be created.

In step D12, the specific situation creation unit 110 obtains the number of specific situations calculated by the specific situation number calculation unit 109 at the timing when the designated time T1 is reached in the occurrence detection by the specific situation monitoring unit 108.

In step D13, the specific situation creation unit 110 refers to the presentation sentence database 1055 to read, among the specific situations registered in the presentation sentence database 1055, specific situations of the number of specific situations other than the specific situations detected by the specific situation monitoring unit 108. The specific situation creation unit 110 causes the display 17 to display the presentation sentences of the number of those specific situations.

In step D14, the receiver reads out the presentation sentence (question sentence and guidance sentence) displayed on the display 17, or speaks the question sentence and the guidance sentence according to the contents of the presentation sentence to the caller.

In step D15, the specific situation creation unit 110 detects a phrase (specific situation phrase) included in the specific situation from the utterance of the caller.

In step D16, the specific situation creation unit 110 stores information related to the specific situation corresponding to the detected specific situation phrase in a predetermined storage area of the memory 12, the storage device 13, or the like. Thereafter, the process is terminated.

Furthermore, only the process of steps D2 to D10 may be carried out if the designated time T1 coincides with the maximum section of the call time of the ongoing remote call in step D1. Furthermore, the process of steps D11 to D16 may be carried out if the designated time T1 is 0.

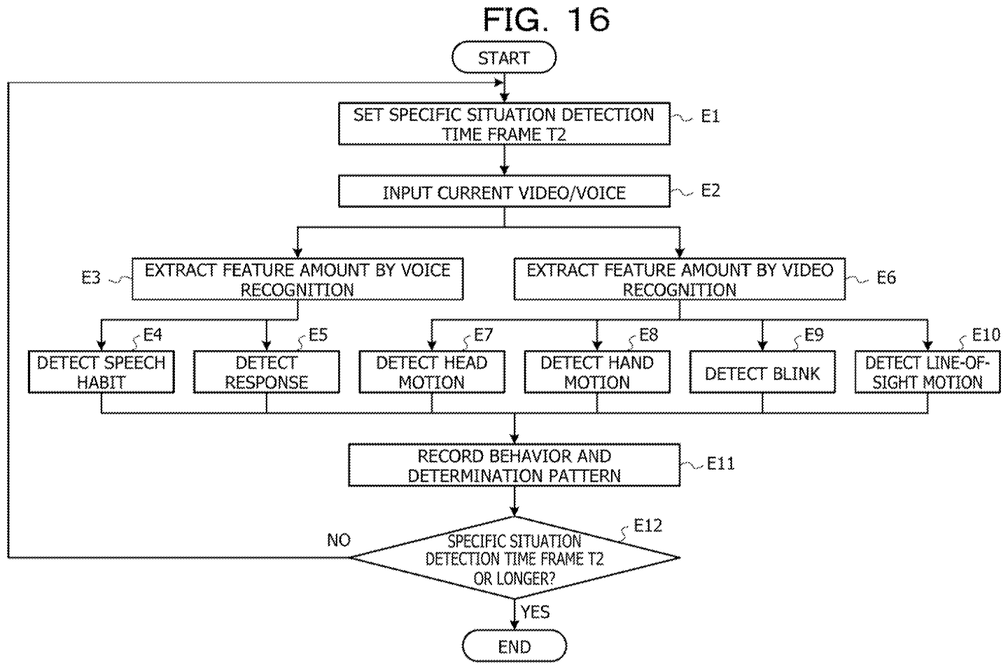

Next, a process of the second behavior extraction unit 111 in the computer system 1 as an example of the first embodiment will be described with reference to a flowchart (steps E1 to E12) illustrated in FIG. 16.

In step E1, the second behavior extraction unit 111 sets the specific situation detection time frame T2.

In step E2, the video data of the remote conversation currently in progress is input to the second behavior extraction unit 111.

In step E3, the second behavior extraction unit 111 extracts, by voice recognition, the feature amount (voice feature points) from the voice data in the specific situation detection time period in the video of the current remote conversation. Thereafter, the process proceeds to steps E4 and E5.

In step E4, the second behavior extraction unit 111 performs speech habit detection on the basis of the voice feature points.

In step E5, the second behavior extraction unit 111 performs response detection on the basis of the voice feature points.

Furthermore, the process of steps E6 to E10 is carried out in parallel with the process of steps E3 to E5 described above.

In step E6, the second behavior extraction unit 111 extracts, by image recognition, the feature amount (image feature points) from the video data in the specific situation detection time period in the video of the current remote conversation. Thereafter, the process proceeds to steps E7 to E10.

In step E7, the second behavior extraction unit 111 performs head motion detection on the basis of the image feature points.

In step E8, the second behavior extraction unit 111 performs hand motion detection on the basis of the image feature points.

In step E9, the second behavior extraction unit 111 performs blink detection on the basis of the image feature points.

In step E10, the second behavior extraction unit 111 performs line-of-sight motion detection on the basis of the image feature points.

Thereafter, in step E11, the second behavior extraction unit 111 stores information regarding the detected specific situation behavior and the determination pattern in a predetermined storage area of the memory 12 or the storage device 13.

In step E12, the second behavior extraction unit 111 checks whether the elapsed time from the start of the specific situation behavior detection is equal to or longer than the specific situation detection time frame T2. If the elapsed time is shorter than the specific situation detection time frame T2 as a result of the checking (see NO route in step E12), the process returns to step E1.

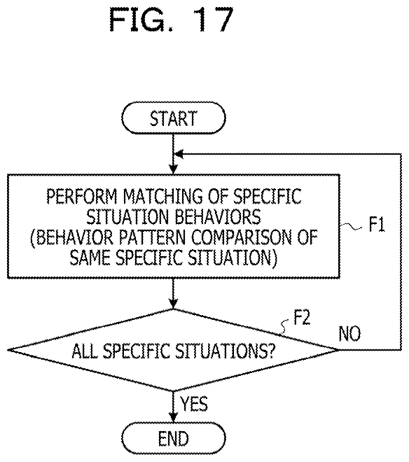

Furthermore, if the elapsed time is equal to or longer than the specific situation detection time frame T2 (see YES route in step E12), the process is terminated. The process proceeds to a process of the behavior comparison unit 112 illustrated in FIG. 17.

Next, the process of the behavior comparison unit 112 in the computer system 1 as an example of the first embodiment will be described with reference to a flowchart (steps F1 and F2) illustrated in FIG. 17.

The behavior comparison unit 112 compares each specific situation behavior extracted by the second behavior extraction unit 111 with the behaviors and the determination patterns registered in the specific situation behavior database 1052.

In step F1, the behavior comparison unit 112 performs matching between the specific situation behavior extracted by the second behavior extraction unit 111 and the behavior registered in the specific situation behavior database 1052.

The behavior comparison unit 112 determines, for all the specific situations in the specific situation behavior database 1052, whether the specific situation behavior and the determination pattern match the specific situation behavior and the determination pattern with the corresponding specific situation among the current specific situation behaviors extracted by the second behavior extraction unit 111.

In step F2, the behavior comparison unit 112 checks whether the matching with the current specific situation behavior has been performed on all the specific situations registered in the specific situation behavior database 1052.

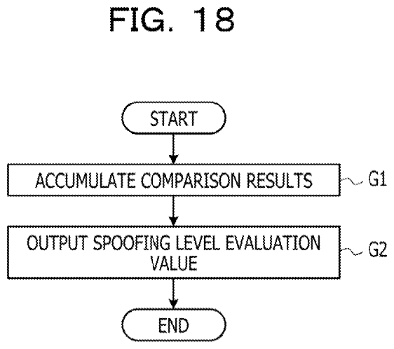

If there is a specific situation that has not been matched with the current specific situation behavior as a result of the checking (see NO route in step F2), the process returns to step F1. Furthermore, if the matching with the current specific situation behavior has been performed on all the specific situations (see YES route in step F2), the process is terminated. The process proceeds to a process of the evaluation unit 113 illustrated in FIG. 18.

Next, the process of the evaluation unit 113 in the computer system 1 as an example of the first embodiment will be described with reference to a flowchart (steps G1 and G2) illustrated in FIG. 18.

In step G1, the comparison results by the behavior comparison unit 112 are stored (accumulated and cumulated) in a predetermined storage area of the memory 12 or the storage device 13.

In step G2, the evaluation unit 113 calculates a value representing the spoofing level (spoofing level evaluation value) on the basis of the comparison results by the behavior comparison unit 112. Furthermore, the evaluation unit 113 causes the display 17 to display (output) the calculated spoofing level evaluation value (spoofing level), thereby making notification to the receiver. Thereafter, the process is terminated.

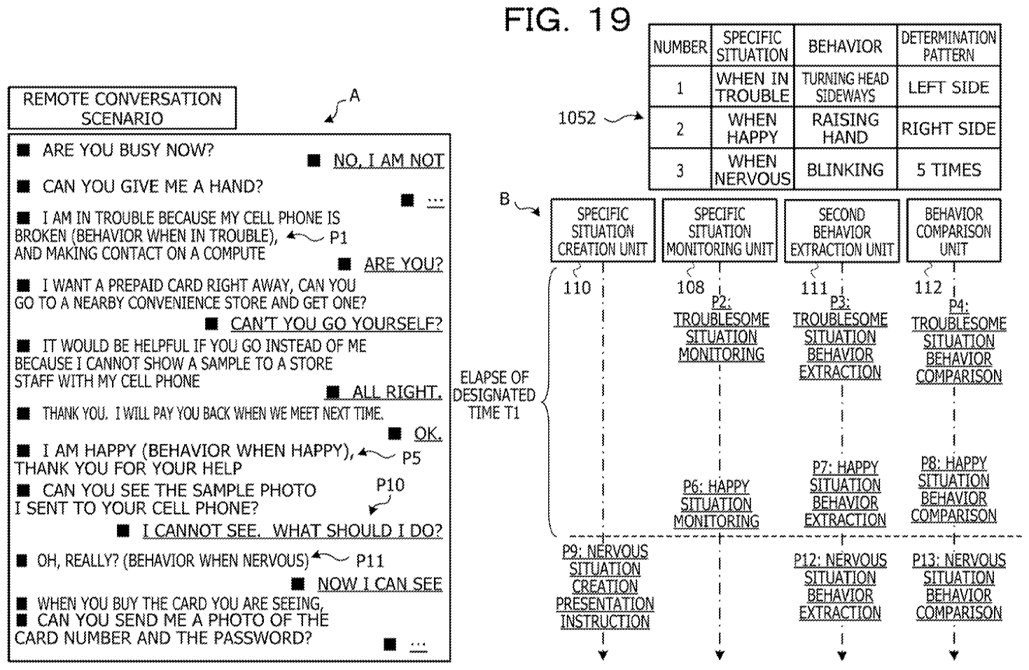

FIG. 19 is a diagram exemplifying simulation using spoofing detection processing in the computer system 1 as an example of the first embodiment.

FIG. 19 illustrates an exemplary case where a remote conversation, which may be a prepaid card fraud, is performed between the caller and the receiver.

In FIG. 19, a reference sign A indicates a scenario of the remote conversation performed between the caller and the receiver, where the underlined statements indicate statements of the receiver and the unlined statements indicate statements of the caller.

Furthermore, a reference sign B in FIG. 19 indicates the individual processes of the specific situation creation unit 110, the specific situation monitoring unit 108, the second behavior extraction unit 111, and the behavior comparison unit 112 of the information processing apparatus 10. Furthermore, FIG. 19 also illustrates the specific situation behavior database 1052.

When the caller says “I am in trouble because my cell phone is broken” along with the behavior when in trouble (see reference sign P1), the specific situation monitoring unit 108 detects the specific situation “when in trouble” on the basis of the specific phrase and the specific facial expression of the caller in this statement (see reference sign P2).

The second behavior extraction unit 111 detects characteristic behavior (behavior when in trouble) of the caller for the specific situation detected by the specific situation monitoring unit 108 and the specific situation generated by the second specific situation determination unit 107 from the video of the remote conversation being performed in real time (see reference sign P3).

The behavior comparison unit 112 compares the current specific situation behavior (behavior when in trouble) extracted by the second behavior extraction unit 111 with the behaviors and the determination patterns registered in the specific situation behavior database 1052 (see reference sign P4).

Furthermore, when the caller says “I am happy” along with the behavior when happy (see reference sign P5), the specific situation monitoring unit 108 detects the specific situation “when happy” on the basis of the specific phrase in this statement and the specific facial expression of the caller (see reference sign P6).

The second behavior extraction unit 111 detects characteristic behavior (behavior when happy) of the caller for the specific situation detected by the specific situation monitoring unit 108 and the specific situation generated by the second specific situation determination unit 107 from the video of the remote conversation being performed in real time (see reference sign P7).

The behavior comparison unit 112 compares the current specific situation behavior (behavior when happy) extracted by the second behavior extraction unit 111 with the behaviors and the determination patterns registered in the specific situation behavior database 1052 (see reference sign P8).

Here, a specific situation “when nervous” is also recorded in the specific situation behavior database 1052 in addition to the specific situations “when in trouble” and “when happy”, and thus three specific situations are recorded.

The specific situation number calculation unit 109 subtracts the number of determined specific situations (2) detected (determined) by the specific situation monitoring unit 108 from the total number of specific situations (3) registered in the specific situation behavior database 1052, thereby obtaining the number of specific situations required to be created (1).

The specific situation creation unit 110 obtains, from the presentation sentence database 1055, a presentation sentence for causing the specific situation “when nervous”, which is registered in the specific situation behavior database 1052 but is not detected by the specific situation monitoring unit 108, and presents it to the receiver (see reference sign P9).

The receiver reads out the presentation sentence (question sentence and guidance sentence) for causing the specific situation “when nervous” displayed on the display 17, or speaks the question sentence and the guidance sentence according to the contents of the presentation sentence to the caller. In the example illustrated in FIG. 19, the receiver speaks the question sentence “I cannot see. What should I do?” to the caller (reference sign P10).

In response to this question sentence, the caller says “Oh, really?” along with the behavior when nervous (see reference sign P11).

The second behavior extraction unit 111 detects characteristic behavior (behavior when nervous) of the caller for the specific situation detected by the specific situation monitoring unit 108 and the specific situation generated by the second specific situation determination unit 107 from the video of the remote conversation being performed in real time (see reference sign P12).

The behavior comparison unit 112 compares the current specific situation behavior (behavior when nervous) extracted by the second behavior extraction unit 111 with the behaviors and the determination patterns registered in the specific situation behavior database 1052 (see reference sign P13).

As a result, the current specific situation behaviors corresponding to all the specific situations registered in the specific situation behavior database 1052 are obtained, and then the processes by the behavior comparison unit 112 and the evaluation unit 113 are executed.

(C) Effects

As described above, according to the computer system 1 as an example of the first embodiment, the specific situation monitoring unit 108 monitors specific situations, and the specific situation creation unit 110 generates the specific situations. This makes it possible to generate the specific situations detected in the previous remote conversation during the remote conversation.

Then, the behavior comparison unit 112 compares the behavior of the caller detected in such a specific situation in the past with the behavior taken by the caller in real time in the specific situation generated during the remote conversation, and the evaluation unit 113 makes an evaluation (calculates a spoofing level), whereby it becomes possible to easily determine whether the caller in the remote conversation is spoofed by an attacker.

The specific situation creation unit 110 outputs a presentation sentence for causing the receiver to ask a question to the caller or outputs a presentation sentence for guiding the receiver so that the other party takes the expected behavior, whereby a specific situation may be easily generated.

(II) Description of Second Embodiment

(A) Configuration

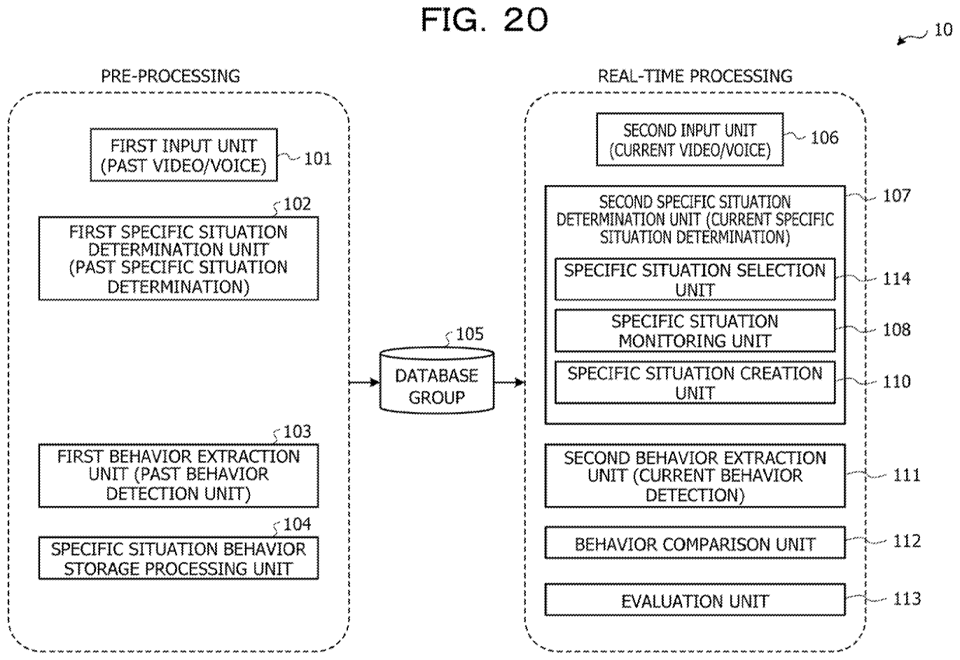

FIG. 20 is a diagram exemplifying a functional configuration of a computer system 1 as an example of a second embodiment.

As illustrated in FIG. 20, the computer system 1 according to the second embodiment includes a specific situation selection unit 114 in place of the specific situation number calculation unit 109 in the computer system 1 according to the first embodiment, and other components are configured in a similar manner to the computer system 1 according to the first embodiment.

In the present second embodiment, a processor 11 executes a determination program, thereby implementing functions as a first input unit 101, a first specific situation determination unit 102, a first behavior extraction unit 103, a specific situation behavior storage processing unit 104, a second input unit 106, a second specific situation determination unit 107 (specific situation selection unit 114, specific situation monitoring unit 108, and specific situation creation unit 110), a second behavior extraction unit 111, a behavior comparison unit 112, and an evaluation unit 113.

Reference signs same as the aforementioned reference signs denote similar components in the drawing, and thus descriptions thereof will be omitted.

The specific situation selection unit 114 separates a specific situation to be detected by the specific situation monitoring unit 108 from the video of the ongoing remote conversation and a specific situation to be generated by the specific situation creation unit 110.

The specific situation selection unit 114 obtains a specific situation from a specific situation behavior database 1052.

Then, the specific situation selection unit 114 calculates an occurrence frequency of the specific situation for each specific situation type. The specific situation selection unit 114 calculates the occurrence frequency for all specific situation types.

The specific situation selection unit 114 registers the calculated occurrence frequency for each specific situation type in a specific situation frequency database 1056.

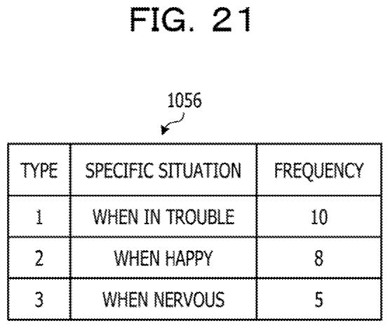

FIG. 21 is a diagram exemplifying the specific situation frequency database 1056 in the computer system 1 as an example of the second embodiment.

In the specific situation frequency database 1056 exemplified in FIG. 21, a frequency is associated with a specific situation. Furthermore, each specific situation is associated with a type representing the specific situation.

The occurrence frequency of the specific situation is accumulated from the past to the present, and is updated by input data.

When the occurrence frequency of a specific situation is higher than a selection threshold value Th, the specific situation selection unit 114 classifies the specific situation to be processed by the specific situation monitoring unit 108. When the occurrence frequency of a specific situation is equal to or lower than the selection threshold value Th, the specific situation selection unit 114 classifies the specific situation to be processed by the specific situation creation unit 110.

The selection threshold value Th may be, for example, an intermediate value of the occurrence frequency, or may be optionally set by a receiver in advance.

For example, in the specific situation frequency database 1056 exemplified in FIG. 21, when the selection threshold value Th=8, the frequency “10” of the specific situation “when in trouble” is equal to or higher than the selection threshold value Th. Accordingly, the specific situation selection unit 114 classifies this specific situation “when in trouble” to be processed by the specific situation monitoring unit 108.

Meanwhile, the frequency of the specific situation “when happy” is “8”, and the frequency of the specific situation “when nervous” is “5”, both of which are equal to or lower than the selection threshold value Th. Accordingly, the specific situation selection unit 114 classifies those specific situations “when happy” and “when nervous” to be processed by the specific situation creation unit 110.

Note that the specific situation selection unit 114 may present all the types of specific situations to the receiver to cause the receiver to select which of the specific situation monitoring unit 108 and the specific situation creation unit 110 is to process each specific situation.

(B) Operation

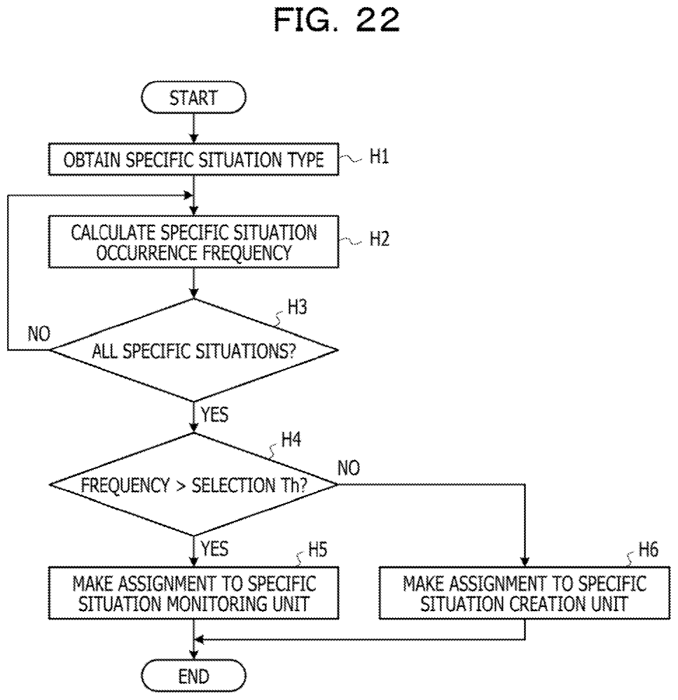

Next, a process of the specific situation selection unit 114 in the computer system 1 as an example of the second embodiment will be described with reference to a flowchart (steps H1 to H16) illustrated in FIG. 22.

In step H1, the specific situation selection unit 114 obtains a specific situation from the specific situation behavior database 1052.

In step H2, the specific situation selection unit 114 calculates an occurrence frequency of the specific situation for each specific situation type. The specific situation selection unit 114 calculates the occurrence frequency for all the specific situations registered in the specific situation behavior database 1052. Furthermore, the specific situation selection unit 114 accumulates the calculated occurrence frequencies for each specific situation.

In step H3, the specific situation selection unit 114 checks whether the occurrence frequency has been calculated for all the specific situations registered in the specific situation behavior database 1052.

As a result of the checking, if there is a specific situation for which the occurrence frequency has not been calculated in the specific situations registered in the specific situation behavior database 1052 (see NO route in step H3), the process returns to step H2.

Furthermore, if the occurrence frequency has been calculated for all the specific situations registered in the specific situation behavior database 1052 (see YES route in step H3), the process proceeds to step H4.

In step H4, the specific situation selection unit 114 compares the occurrence frequency of the specific situation with the selection threshold value Th. If the occurrence frequency of the specific situation is higher than the selection threshold value Th as a result of the comparison (see YES route in step H4), the specific situation selection unit 114 assigns the specific situation to the specific situation monitoring unit 108 (step H5).

On the other hand, if the occurrence frequency of the specific situation is equal to or lower than the selection threshold value Th (see NO route in step H4), the specific situation selection unit 114 assigns the specific situation to the specific situation creation unit 110 (step H6). Thereafter, the process is terminated.

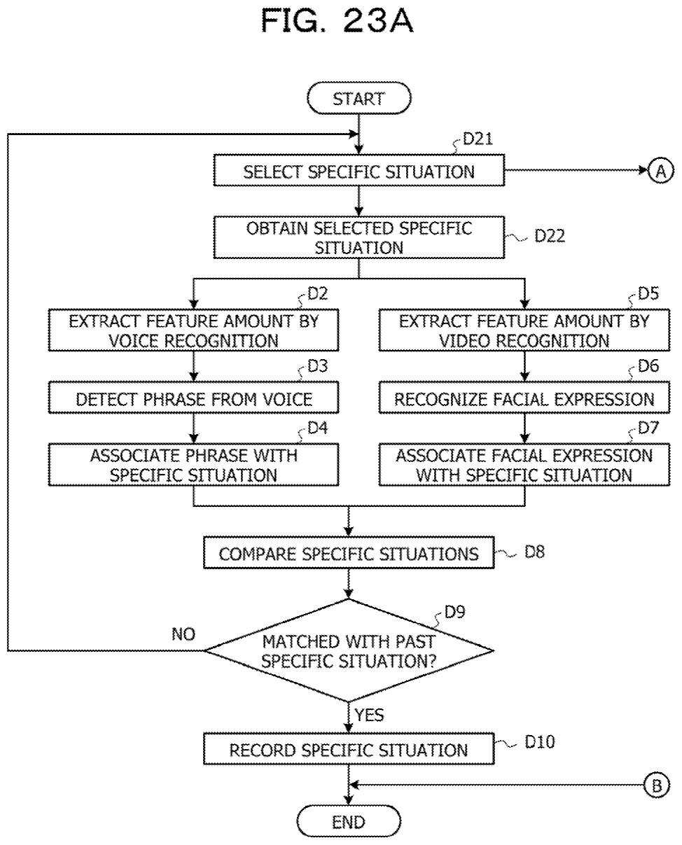

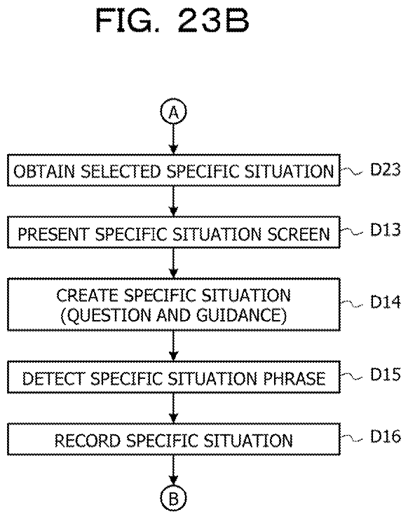

Next, a process of the second specific situation determination unit 107 in the computer system 1 as an example of the second embodiment will be described with reference to a flowchart (steps D21, D22, D2 to D10, D23, and D13 to D16) illustrated in FIGS. 23A and 23B.

Processing denoted by reference signs same as the aforementioned reference signs indicate similar processing in the drawing, and descriptions thereof will be omitted.

In the present process, the video data of the ongoing remote conversation is input to the second specific situation determination unit 107, and the second specific situation determination unit 107 processes the video data of the ongoing remote conversation.

In step D21, the specific situation selection unit 114 selects whether a specific situation is to be processed by the specific situation monitoring unit 108 or to be processed by the specific situation creation unit 110 on the basis of the frequency in the specific situation frequency database 1056.

Thereafter, the process proceeds to steps D22 and D23.

In step D22, the specific situation monitoring unit 108 obtains the specific situation assigned to itself. Thereafter, each processing of steps D2 to D10 is executed.

Meanwhile, in step D23, the specific situation creation unit 110 obtains the specific situation assigned to itself. Thereafter, each processing of steps D13 to D16 is executed.

Furthermore, the present flow is terminated after each processing of steps D10 and D16.

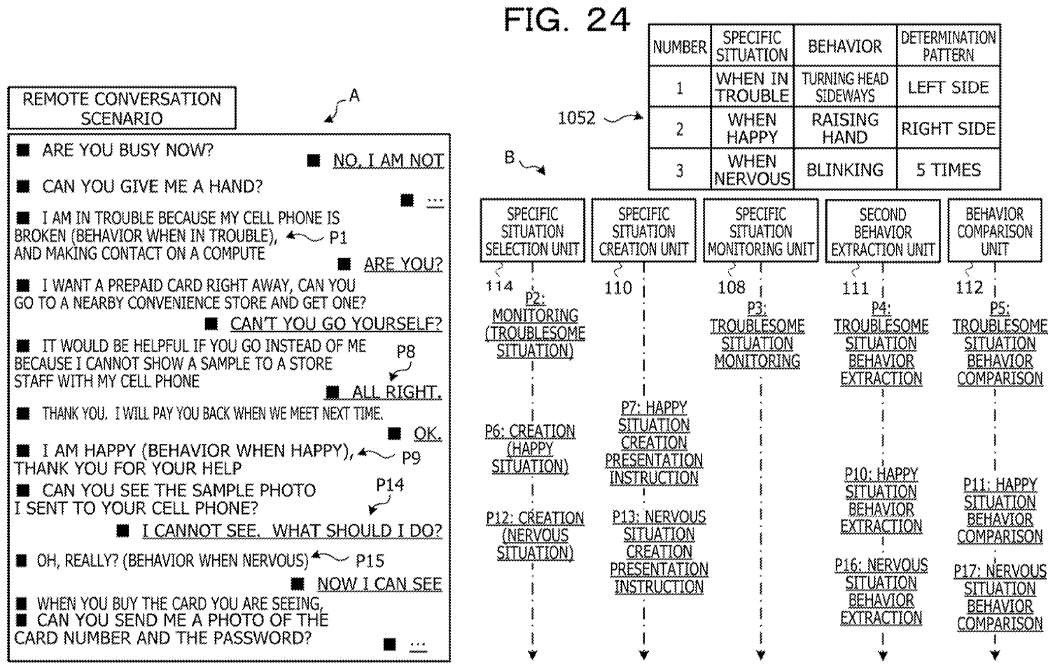

FIG. 24 is a diagram exemplifying simulation using spoofing detection processing in the computer system 1 as an example of the second embodiment.

FIG. 24 also illustrates an exemplary case where a remote conversation, which may be a prepaid card fraud, is performed between a caller and a receiver.

In FIG. 24, a reference sign A indicates a scenario of the remote conversation performed between the caller and the receiver, where the underlined statements indicate statements of the receiver and the unlined statements indicate statements of the caller.

Furthermore, a reference sign B in FIG. 24 indicates the individual processes of the specific situation selection unit 114, the specific situation creation unit 110, the specific situation monitoring unit 108, the second behavior extraction unit 111, and the behavior comparison unit 112 of the information processing apparatus 10. Furthermore, FIG. 24 also illustrates the specific situation behavior database 1052.

The specific situation selection unit 114 refers to the specific situation frequency database 1056 to compare the occurrence frequency of the specific situation “when in trouble” with the selection threshold value Th, and assigns the specific situation “when in trouble” to the specific situation monitoring unit 108 (see reference sign P2).

Furthermore, the specific situation selection unit 114 refers to the specific situation frequency database 1056 to compare the frequency of the specific situation “when happy” with the selection threshold value Th, and assigns the specific situation “when happy” to the specific situation creation unit 110 (see reference sign P6).

Furthermore, the specific situation selection unit 114 refers to the specific situation frequency database 1056 to compare the frequency of the specific situation “when nervous” with the selection threshold value Th, and assigns the specific situation “when nervous” to the specific situation creation unit 110 (see reference sign P12). For example, the specific situation selection unit 114 collectively processes the selection of the individual situations of “when in trouble”, “when happy”, and “when nervous”.

The specific situation monitoring unit 108 detects the specific situation “when in trouble” on the basis of the specific phrase in the statement and the specific facial expression of the caller (see reference sign P3).

The second behavior extraction unit 111 detects characteristic behavior (behavior when in trouble) of the caller for the specific situation detected by the specific situation monitoring unit 108 and the specific situation generated by the second specific situation determination unit 107 from the video of the remote conversation being performed in real time (see reference sign P4).

The behavior comparison unit 112 compares the current specific situation behavior (behavior when in trouble) extracted by the second behavior extraction unit 111 with the behaviors and the determination patterns registered in the specific situation behavior database 1052 (see reference sign P5).

The specific situation creation unit 110 obtains a presentation sentence for generating the specific situation “when happy” from a presentation sentence database 1055, and presents it to the receiver (see reference sign P7).

The receiver reads out the presentation sentence (question sentence and guidance sentence) for causing the specific situation “when happy” displayed on a display 17, or speaks the question sentence and the guidance sentence according to the contents of the presentation sentence to the caller. In the example illustrated in FIG. 24, the receiver says “all right” to the caller (see reference sign P8).

When the caller says “I am happy, that is helpful” in response to this question sentence along with the behavior when happy (see reference sign P9), the specific situation monitoring unit 108 detects the specific situation “when happy” on the basis of the specific phrase in this statement and the specific facial expression of the caller.

The second behavior extraction unit 111 detects characteristic behavior (behavior when happy) of the caller for the specific situation detected by the specific situation monitoring unit 108 and the specific situation generated by the second specific situation determination unit 107 from the video of the remote conversation being performed in real time (see reference sign P10).

The behavior comparison unit 112 compares the current specific situation behavior (behavior when happy) extracted by the second behavior extraction unit 111 with the behaviors and the determination patterns registered in the specific situation behavior database 1052 (see reference sign P11).

The specific situation creation unit 110 obtains a presentation sentence for generating the specific situation “when nervous” from the presentation sentence database 1055, and presents it to the receiver (see reference sign P13).

The receiver reads out the presentation sentence (question sentence and guidance sentence) for causing the specific situation “when nervous” displayed on the display 17, or speaks the question sentence and the guidance sentence according to the contents of the presentation sentence to the caller. In the example illustrated in FIG. 24, the receiver says “I cannot see. What should I do?” to the caller (see reference sign P14).

When the caller says “Oh, really?” in response to this question sentence along with the behavior when nervous (see reference sign P15), the specific situation monitoring unit 108 detects the specific situation “when nervous” on the basis of the specific phrase in this statement and the specific facial expression of the caller.

The second behavior extraction unit 111 detects characteristic behavior (behavior when nervous) of the caller for the specific situation detected by the specific situation monitoring unit 108 and the specific situation generated by the second specific situation determination unit 107 from the video of the remote conversation being performed in real time (see reference sign P16).

The behavior comparison unit 112 compares the current specific situation behavior (behavior when nervous) extracted by the second behavior extraction unit 111 with the behaviors and the determination patterns registered in the specific situation behavior database 1052 (see reference sign P17).

As a result, the current specific situation behaviors corresponding to all the specific situations registered in the specific situation behavior database 1052 are obtained, and then the processes by the behavior comparison unit 112 and the evaluation unit 113 are executed.

(C) Effects

As described above, according to the computer system 1 as an example of the second embodiment, working effects similar to those of the first embodiment described above may be obtained, and the specific situation selection unit 114 selects the specific situation to be processed by the specific situation monitoring unit 108 and the specific situation to be processed by the specific situation creation unit 110.

As a result, it becomes possible to shorten the time needed to make specific situation determination. Furthermore, in the specific situation selection process, the accuracy in the selection may be further improved by accumulating the past specific situation data.

(III) Description of Third Embodiment

(A) Configuration

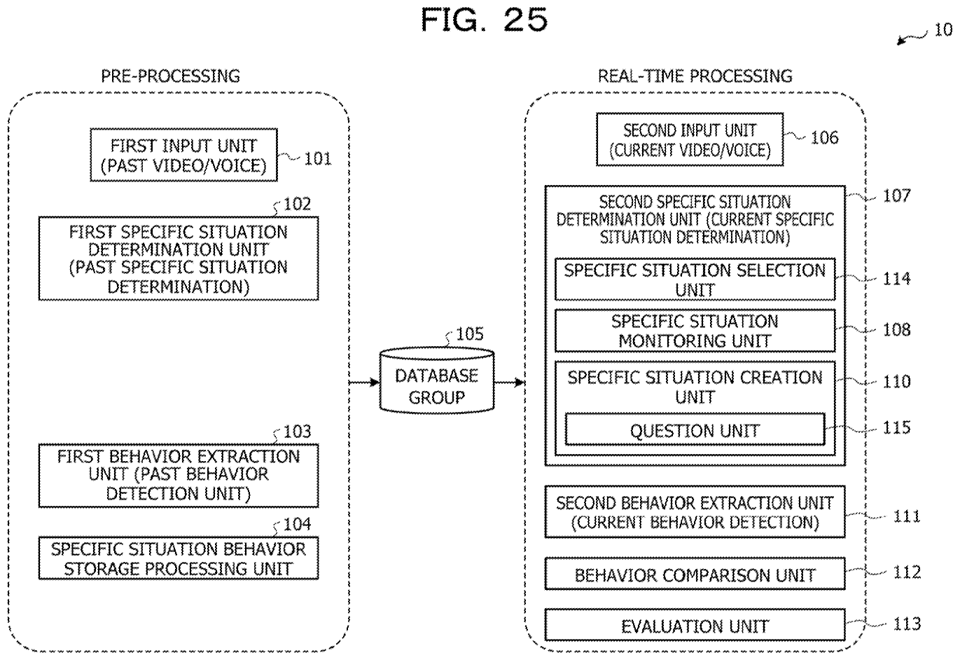

FIG. 25 is a diagram exemplifying a functional configuration of a computer system 1 as an example of a third embodiment.

As illustrated in FIG. 25, the computer system 1 according to the third embodiment has a function of a question unit 115 in the specific situation creation unit 110 in the computer system 1 according to the second embodiment, and other components are configured in a similar manner to the computer system 1 according to the second embodiment.

In the present third embodiment, a processor 11 executes a determination program, thereby implementing functions as a first input unit 101, a first specific situation determination unit 102, a first behavior extraction unit 103, a specific situation behavior storage processing unit 104, a second input unit 106, a second specific situation determination unit 107 (specific situation selection unit 114, specific situation monitoring unit 108, specific situation creation unit 110, and question unit 115), a second behavior extraction unit 111, a behavior comparison unit 112, and an evaluation unit 113.

The question unit 115 presents a method for achieving a specific situation to be applied to a receiver, and the receiver takes an action according to the presented method to a caller, thereby generating the specific situation.

For example, the question unit 115 presents, to the receiver, a specific situation and a question sentence to be asked from the receiver to the caller to achieve the specific situation.

For example, the question unit 115 causes a display 17 of an information processing apparatus 10 to display a specific situation and a question sentence to achieve the specific situation.

In the computer system 1 according to the present third embodiment, specific situation creation question information in which specific situations of multiple types are associated with individual question sentences to be asked from the receiver to the caller to achieve the individual specific situations is stored in a predetermined storage area of a storage device 13 or the like in advance.

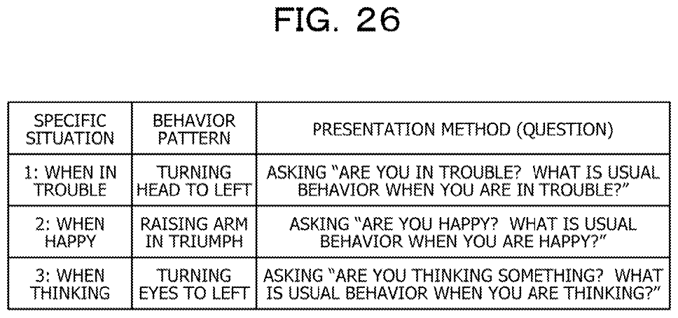

FIG. 26 is a diagram exemplifying the specific situation creation question information in the computer system 1 as an example of the third embodiment.

In the specific situation creation question information exemplified in FIG. 26, a behavior pattern and a presentation method (question) are associated with a specific situation.

The presentation method (question) is advice to be presented to the receiver, and for example, “asking “Are you in trouble? What is the usual behavior when you are in trouble?”” is set as a presentation method (question) in the specific situation “when happy”.

When the receiver asks the caller “Are you in trouble? What is the usual behavior when you are in trouble?” according to this presentation method (question), the caller may be caused to take the behavior in the specific situation “when in trouble”.

(B) Operation

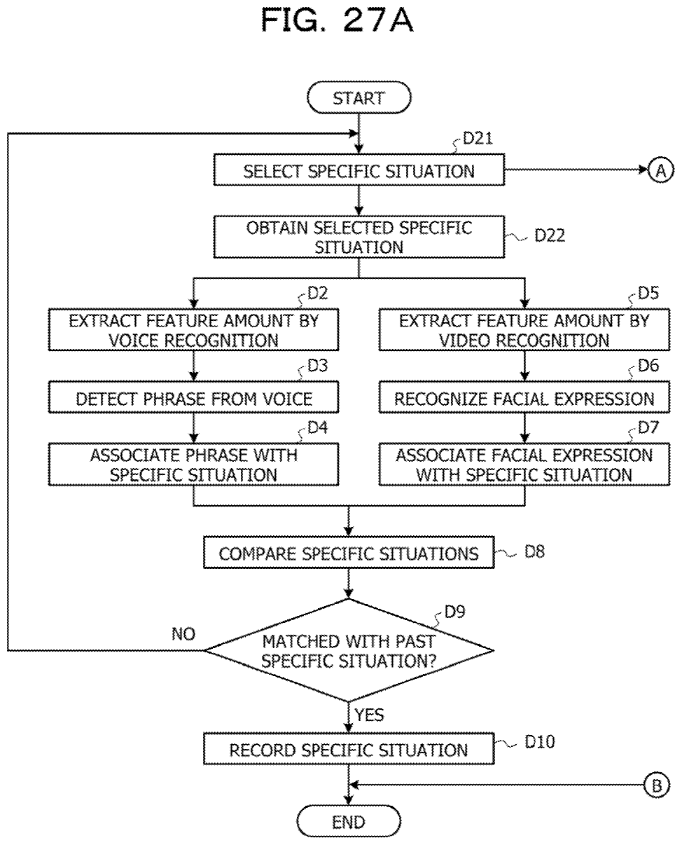

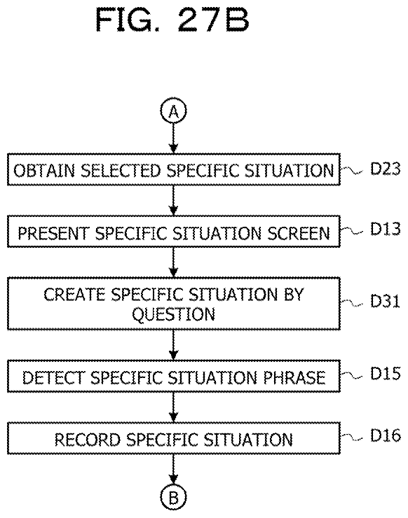

A process of the second specific situation determination unit 107 in the computer system 1 as an example of the third embodiment will be described with reference to a flowchart (steps D21, D22, D2 to D10, D23, D13, D31, D15, and D16) illustrated in FIGS. 27A and 27B.

Processing denoted by reference signs same as the aforementioned reference signs indicate similar processing in the drawing, and descriptions thereof will be omitted.

In step D31, the question unit 115 presents a method (question sentence) for achieving a specific situation to the receiver, and the receiver asks the presented question sentence to the caller, thereby generating the specific situation.

Thereafter, the process of steps D15 and D16 is carried out, and the process is terminated.

(C) Effects

As described above, according to the computer system 1 as an example of the third embodiment, working effects similar to those of the second embodiment described above may be obtained, and the question unit 115 presents a method (question sentence) for achieving a specific situation to the receiver, and the receiver asks the presented question sentence to the caller, thereby generating the specific situation. As a result, it becomes possible to reliably generate a specific situation.

(IV) Description of Fourth Embodiment

(A) Configuration

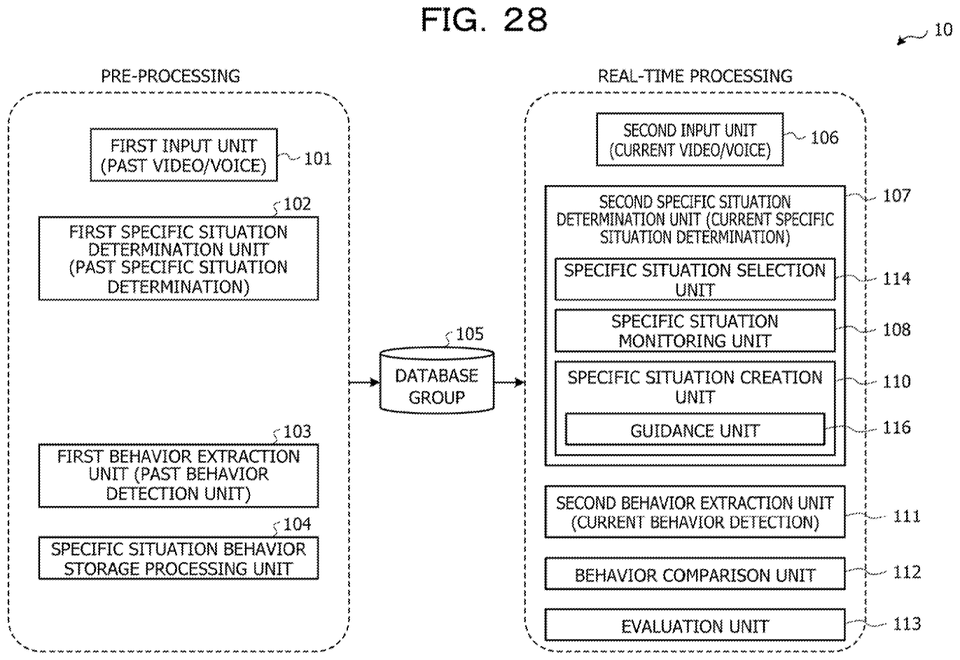

FIG. 28 is a diagram exemplifying a functional configuration of a computer system 1 as an example of a fourth embodiment.

As illustrated in FIG. 28, the computer system 1 according to the fourth embodiment has a function of a guidance unit 116 instead of the question unit 115 in the specific situation creation unit 110 in the computer system 1 according to the third embodiment, and other components are configured in a similar manner to the computer system 1 according to the third embodiment.

In the present fourth embodiment, a processor 11 executes a determination program, thereby implementing functions as a first input unit 101, a first specific situation determination unit 102, a first behavior extraction unit 103, a specific situation behavior storage processing unit 104, a second input unit 106, a second specific situation determination unit 107 (specific situation selection unit 114, specific situation monitoring unit 108, specific situation creation unit 110, and guidance unit 116), a second behavior extraction unit 111, a behavior comparison unit 112, and an evaluation unit 113.

The guidance unit 116 presents a method for achieving a specific situation to be applied to a receiver, and the receiver takes an action according to the presented method to a caller, thereby generating the specific situation.

For example, the guidance unit 116 presents, to the receiver, a specific situation and an action to be taken by the receiver for guiding the caller to achieve the specific situation.

For example, the guidance unit 116 causes a display 17 of an information processing apparatus 10 to display a specific situation and an action to be taken by the receiver to lead to the specific situation.

In the computer system 1 according to the present fourth embodiment, specific situation guidance information in which specific situations of multiple types are associated with individual action contents to be taken by the receiver to achieve the individual specific situations is stored in a predetermined storage area of a storage device 13 or the like in advance.

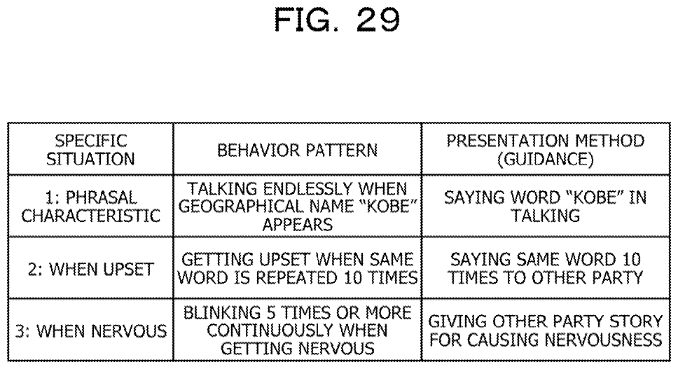

FIG. 29 is a diagram exemplifying the specific situation guidance information in the computer system 1 as an example of the fourth embodiment.

In the specific situation guidance information exemplified in FIG. 29, a behavior pattern and a presentation method (guidance) are associated with a specific situation.

The behavior pattern is, for example, a behavior pattern of the caller detected in a remote conversation performed in the past. For example, in the specific situation “when upset”, “getting upset when the same word is repeated 10 times” is set as a behavior pattern.

The presentation method (guidance) is information (advice) indicating an action to be taken by the receiver to generate a specific situation, and for example, “saying the same word 10 times to the other party” is set in the specific situation “when upset”.

The guidance unit 116 reads, from the specific situation guidance information, the contents of the presentation method (guidance) corresponding to the specific situation, and presents it to the receiver.

The specific situation guidance information may be optionally set by the receiver. Furthermore, in the present computer system 1, it may be generated by the system using the behavior detected when a specific situation behavior database 1052 is created, for example.

(B) Operation

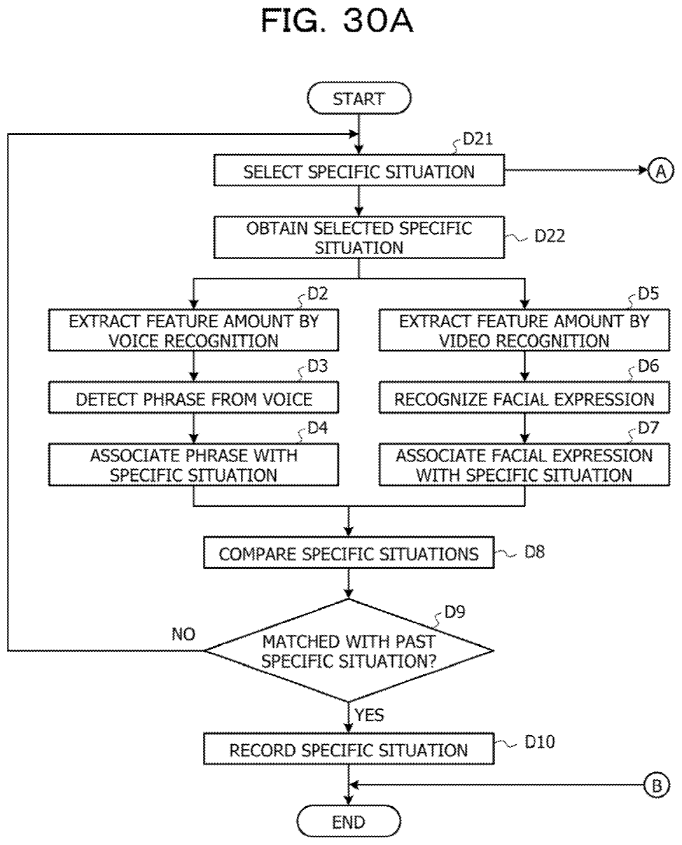

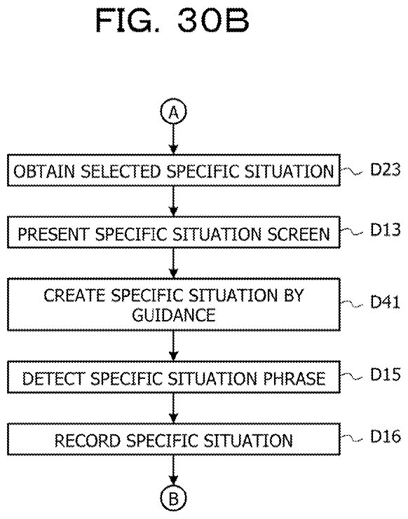

A process of the second specific situation determination unit 107 in the computer system 1 as an example of the fourth embodiment will be described with reference to a flowchart (steps D21, D22, D2 to D10, D23, D13, D41, D15, and D16) illustrated in FIGS. 30A and 30B.

Processing denoted by reference signs same as the aforementioned reference signs indicate similar processing in the drawing, and descriptions thereof will be omitted.

In step D41, the guidance unit 116 presents, to the receiver, the contents of the presentation method (guidance) corresponding to the specific situation obtained from the specific situation guidance information, and the receiver takes an action corresponding to the presented contents, thereby generating the specific situation.

Thereafter, the process of steps D15 and D16 is carried out, and the process is terminated.

(C) Effects

As described above, according to the computer system 1 as an example of the fourth embodiment, working effects similar to those of the third embodiment described above may be obtained, and the guidance unit 116 presents action contents to be taken to achieve a specific situation to the receiver, and the receiver takes the presented action to the caller, thereby generating the specific situation. As a result, it becomes possible to reliably generate a specific situation.

(V) Others

Each configuration and each processing of each embodiment described above may be selected or omitted as needed, or may be appropriately combined.

Additionally, the disclosed techniques are not limited to the embodiments described above, and various modifications may be made and carried out without departing from the gist of the present embodiments.

While the video indicates moving images and the examples of transmitting the moving images from the interlocutor terminal 2 are described in the individual embodiments described above, it is not limited to this. For example, only voice may be transmitted from the interlocutor terminal 2.

In this case, prosody such as intonation and rhythm, phrases, and the like may be extracted from the voice transmitted from the interlocutor terminal 2, and may be used as specific situation behavior.

Furthermore, while the example in which the caller and the receiver have a one-to-one remote conversation is described in each of the embodiments described above, it is not limited to this. The receiver may perform the spoofing detection described in each of the embodiments by a one-to-many or many-to-many remote conversation.

Furthermore, the present embodiments may be carried out and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for determination for causing a computer to execute a process comprising:
receiving first sensing data that includes either video or voice generated in a first remote call made between a first account and a second account and second sensing data that includes either video or voice generated in a second remote call made between the first account and the second account;
referring to a storage unit that stores feature information extracted when a specific situation for a person who corresponds to the first account occurs in the first sensing data in association with the specific situation when occurrence of the specific situation for the person who corresponds to the first account is detected in the second sensing data; and
making determination related to spoofing on a basis of a matching state between the feature information for the specific situation in the storage unit and the feature information for the specific situation detected from the second sensing data.

2. The method according to claim 1, wherein the detecting the occurrence of the specific situation includes
determining, when analytical processing is performed on the first sensing data or the second sensing data and a specific analysis result is detected, a situation associated with the specific analysis result in advance as the specific situation.

3. The method according to claim 1, wherein the making determination related to spoofing includes
calculating an index value that determines the spoofing on a basis of a number of matches between the feature information in the specific situation extracted from the first sensing data and the feature information in the specific situation extracted from the second sensing data.

4. The method according to claim 1, wherein
the first sensing data includes video that images the first account in a remote call previously made between the first account and the second account, and
the second sensing data includes video that images the first account in an ongoing remote call between the first account and the second account.

5. The method according to claim 4, the method causing the computer to execute the process further comprising:
in a case where the specific situation for the person who corresponds to the first account detected on a basis of the first sensing data is different from the specific situation for the person who corresponds to the first account detected on a basis of the second sensing data,
performing specific situation creation processing that generates the specific situation for the person who corresponds to the first account by outputting presentation information to a person who corresponds to the second account who makes the ongoing remote call.

6. The method according to claim 5, the method causing the computer to execute the process further comprising:
calculating an occurrence frequency of the specific situation for the person who corresponds to the first account detected on the basis of the second sensing data;
performing the detecting the occurrence of the specific situation when the occurrence frequency is higher than a threshold value; and
performing the specific situation creation processing when the occurrence frequency is equal to or lower than the threshold value.

7. The method according to claim 5, wherein the presentation information includes a question sentence uttered from the person who corresponds to the second account to the first account.

8. The method according to claim 5, wherein the presentation information includes information extraction learning data that indicates an action to be performed on the first account by the person who corresponds to the second account.

9. An information processing apparatus comprising:
a memory; and
a processor coupled to the memory and configured to:
receive first sensing data that includes either video or voice generated in a first remote call made between a first account and a second account and second sensing data that includes either video or voice generated in a second remote call made between the first account and the second account;
refer to a storage unit that stores feature information extracted when a specific situation for a person who corresponds to the first account occurs in the first sensing data in association with the specific situation when occurrence of the specific situation for the person who corresponds to the first account is detected in the second sensing data; and
make determination related to spoofing on a basis of a matching state between the feature information for the specific situation in the storage unit and the feature information for the specific situation detected from the second sensing data.

10. The information processing apparatus according to claim 9, wherein the processor determines, when analytical processing is performed on the first sensing data or the second sensing data and a specific analysis result is detected, a situation associated with the specific analysis result in advance as the specific situation.

11. The information processing apparatus according to claim 9, wherein the processor calculate an index value that determines the spoofing on a basis of a number of matches between the feature information in the specific situation extracted from the first sensing data and the feature information in the specific situation extracted from the second sensing data.

12. The information processing apparatus according to claim 9, wherein
the first sensing data includes video that images the first account in a remote call previously made between the first account and the second account, and
the second sensing data includes video that images the first account in an ongoing remote call between the first account and the second account.

13. The information processing apparatus according to claim 12, the processor, in a case where the specific situation for the person who corresponds to the first account detected on a basis of the first sensing data is different from the specific situation for the person who corresponds to the first account detected on a basis of the second sensing data, performs specific situation creation processing that generates the specific situation for the person who corresponds to the first account by outputting presentation information to a person who corresponds to the second account who makes the ongoing remote call.

14. The information processing apparatus according to claim 13, the processor:
calculate an occurrence frequency of the specific situation for the person who corresponds to the first account detected on the basis of the second sensing data;
perform the detecting the occurrence of the specific situation when the occurrence frequency is higher than a threshold value; and
perform the specific situation creation processing when the occurrence frequency is equal to or lower than the threshold value.

15. The information processing apparatus according to claim 13, wherein the presentation information includes a question sentence uttered from the person who corresponds to the second account to the first account.

16. The information processing apparatus according to claim 13, wherein the presentation information includes information extraction learning data that indicates an action to be performed on the first account by the person who corresponds to the second account.

17. A non-transitory computer-readable recording medium storing a determination program causing a computer to execute a process comprising:
receiving first sensing data that includes either video or voice generated in a first remote call made between a first account and a second account and second sensing data that includes either video or voice generated in a second remote call made between the first account and the second account;
referring to a storage unit that stores feature information extracted when a specific situation for a person who corresponds to the first account occurs in the first sensing data in association with the specific situation when occurrence of the specific situation for the person who corresponds to the first account is detected in the second sensing data; and
making determination related to spoofing on a basis of a matching state between the feature information for the specific situation in the storage unit and the feature information for the specific situation detected from the second sensing data.

18. The non-transitory computer-readable recording medium according to claim 17, wherein the detecting the occurrence of the specific situation includes
determining, when analytical processing is performed on the first sensing data or the second sensing data and a specific analysis result is detected, a situation associated with the specific analysis result in advance as the specific situation.

19. The non-transitory computer-readable recording medium according to claim 17, wherein the making determination related to spoofing includes
calculating an index value that determines the spoofing on a basis of a number of matches between the feature information in the specific situation extracted from the first sensing data and the feature information in the specific situation extracted from the second sensing data.

20. The non-transitory computer-readable recording medium according to claim 17, wherein
the first sensing data includes video that images the first account in a remote call previously made between the first account and the second account, and
the second sensing data includes video that images the first account in an ongoing remote call between the first account and the second account.
